(19) United States
(12) Patent Application Publication
(10) Pub. No.: US 2014/0092000 A1
(43) Pub. Date: Apr. 3, 2014

(54) IMAGE DISPLAY APPARATUS AND IMAGE DISPLAY METHOD

(71) Applicant: Kabushiki Kaisha Toshiba, Tokyo (JP)

(72) Inventors: Ryosuke NONAKA, Yokohama-Shi (JP); Masahiro BABA, Yokohama-Shi (JP)

(73) Assignee: Kabushiki Kaisha Toshiba, Tokyo (JP)

(21) Appl. No.: 14/012,366

(22) Filed: Aug. 28, 2013

(30) Foreign Application Priority Data
Oct. 1, 2012 (JP) 2012-219685

(51) Int. Cl. G09G 3/34

(52) U.S. Cl. CPC G09G 3/34
USPC 345/102

(57) ABSTRACT

According to some embodiments, there is provided an image display apparatus including: a backlight, a modulation unit, a calculation unit and a control unit. The backlight includes a plurality of light sources, an emission intensity of each light source being controllable. The modulation unit modulates light emitted from the backlight to display an image on a display region. The calculation unit calculates an amount of motion of a video between a previous image and a subsequent image based on an input video signal. The control unit controls the light sources such that a non-uniform distribution of brightness is obtained on the display region as the amount of motion decreases.

### CROSS REFERENCE TO RELATED APPLICATIONS

This application is based upon and claims the benefit of priority from the prior Japanese Patent Application No. 2012-219685 filed on Oct. 1, 2012, the entire contents of which are incorporated herein by reference.

### FIELD

Embodiments relates to an image display apparatus and an image display method.

### BACKGROUND

Heretofore, liquid crystal display devices are configured to control each light source such that gradient in luminance decreases as the amount of change in a histogram of pixel values within one frame of an input video signal decreases.

However, in the case of displaying a video including motion of an entire image (hereinafter “translational motion”) such as a scroll video, the unevenness of each backlight is more easily perceived than in the case of displaying a still video. Thus, the well-known art has a problem in that the unevenness becomes remarkable when a video including a translational motion is displayed, or a sufficient power-saving effect cannot be obtained when a still video is displayed.

### BRIEF DESCRIPTION OF THE DRAWINGS

FIG. 1 illustrates a configuration of a liquid crystal display device according to a first embodiment;

FIGS. 2(a) to 2(c) illustrate a configuration example of a backlight according to the first embodiment;

FIGS. 3(a) to 3(d) illustrate a distribution of brightness of light incident on a liquid crystal panel according to the first embodiment;

FIG. 4A illustrates a configuration example of a direct backlight according to the first embodiment;

FIG. 4B illustrates another configuration example of the direct backlight according to the first embodiment;

FIGS. 5(a) to 5(e) illustrate a configuration example of an edge backlight according to the first embodiment;

FIG. 6 illustrates a configuration example of a liquid crystal control unit and a liquid crystal panel according to the first embodiment;

FIG. 7 is a configuration example of an emission intensity calculation unit according to the first embodiment;

FIG. 8 is a configuration example of a translation amount calculation unit according to the first embodiment;

FIGS. 9(a) and 9(b) illustrate an example of the motion estimation in a motion estimation unit according to the first embodiment;

FIG. 10 illustrates a video region, a block, and a search range according to the first embodiment;

FIG. 11 illustrates another example of the video region and the block according to the first embodiment;

FIG. 12 illustrates an example of an LUT in a peak strength determination unit according to the first embodiment;

FIGS. 13(a) to 13(c) illustrate a configuration example of a backlight according to a second embodiment;

FIGS. 14(a) to 14(d) illustrate a distribution of brightness of light incident on a liquid crystal panel according to the second embodiment;

FIG. 15 illustrates a configuration example of a direct backlight according to the second embodiment;

FIGS. 16(a) to 16(e) illustrate a configuration example of an edge backlight according to the second embodiment;

FIG. 17 illustrates a configuration of an emission intensity calculation unit according to the second embodiment;

FIGS. 18(a) and 18(b) illustrate a relation between a light source and a virtual light source according to the second embodiment;

FIG. 19 illustrates a configuration example of a motion estimation unit according to a third embodiment;

FIG. 20 schematically illustrates operation of a horizontal one-dimensional-projection-image calculation unit according to the third embodiment;

FIG. 21 schematically illustrates operation of a vertical one-dimensional-projection-image calculation unit according to the third embodiment;

FIGS. 22(a) and 22(b) illustrate an operation flow of a vertical motion estimation unit according to the third embodiment;

FIG. 23 illustrates an operation flow of a horizontal motion estimation unit according to the third embodiment;

FIG. 24 illustrates a configuration in which a memory unit is provided in a motion estimation unit according to the third embodiment;

FIG. 25 illustrates a configuration of an emission intensity calculation unit according to a fourth embodiment;

FIG. 26 illustrates a video region and a brightness calculation range according to the fourth embodiment;

FIG. 27 illustrates an example of an LUT in a peak strength determination unit according to the fourth embodiment;

FIG. 28 illustrates an example of the LUT in the peak strength determination unit according to the fourth embodiment;

FIG. 29 illustrates an emission intensity calculation unit according to a fifth embodiment;

FIG. 30 illustrates an example of a configuration of a total gradient calculation unit;

FIG. 31 illustrates a positional relationship between pixels in calculation of a gradient of an input video;

FIG. 32 illustrates a video region and an addition range of a magnitude of a gradient;

FIG. 33 illustrates an example of an LUT in a peak strength determination unit according to the fifth embodiment;

FIG. 34 illustrates an example of the LUT in the peak strength determination unit according to the fifth embodiment; and

FIG. 35 illustrates an example of the LUT in the peak strength determination unit according to the fifth embodiment.

### DETAILED DESCRIPTION

According to some embodiments, there is provided an image display apparatus including: a backlight, a modulation unit, a calculation unit and a control unit.

The backlight includes a plurality of light sources, an emission intensity of each light source being controllable.

The modulation unit modulates light emitted from the backlight to display an image on a display region.

The calculation unit calculates an amount of motion of a video between a previous image and a subsequent image based on an input video signal.

The control unit controls the light sources such that a non-uniform distribution of brightness is obtained on the display region as the amount of motion decreases.

Hereinafter, embodiments will be described in detail with reference to the drawings.

### First Embodiment

A liquid crystal display device according to a first embodiment will be described.

### Configuration of Liquid Crystal Display Device

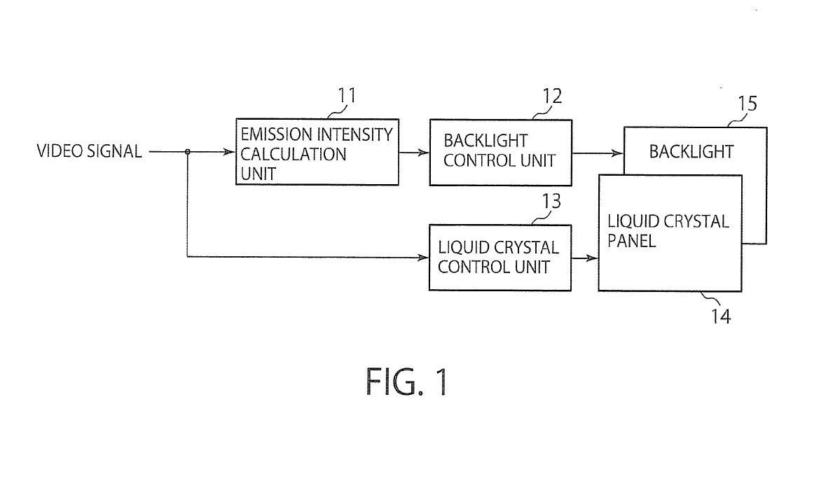

FIG. 1 illustrates a configuration of a liquid crystal display device according to this embodiment. The liquid crystal display device according to this embodiment includes an emission intensity calculation unit 11, a backlight control unit 12, a backlight 15, a liquid crystal control unit 13, and a liquid crystal panel (modulation unit) 14 in which a plurality of pixels is arranged in matrix.

The emission intensity calculation unit 11 calculates an emission intensity of the backlight 15 suitable for display, based on a video signal (hereinafter referred to as “input video signal”) input to the liquid crystal display device. The backlight control unit 12 controls lighting (emission) of the backlight 15 according to the emission intensity calculated by the emission intensity calculation unit 11. The backlight 15 lights according to the control of the backlight control unit 12. The liquid crystal control unit 13 controls the liquid crystal panel 14 based on the input video signal. The liquid crystal panel 14 changes the amount of transmitted light from the backlight 15 according to the control of the liquid crystal control unit 13. That is, the liquid crystal panel 14 modulates the emission of the backlight 15 to thereby display the video in a display region.

The configuration and operation of each unit will be described in detail below.

### Backlight 15

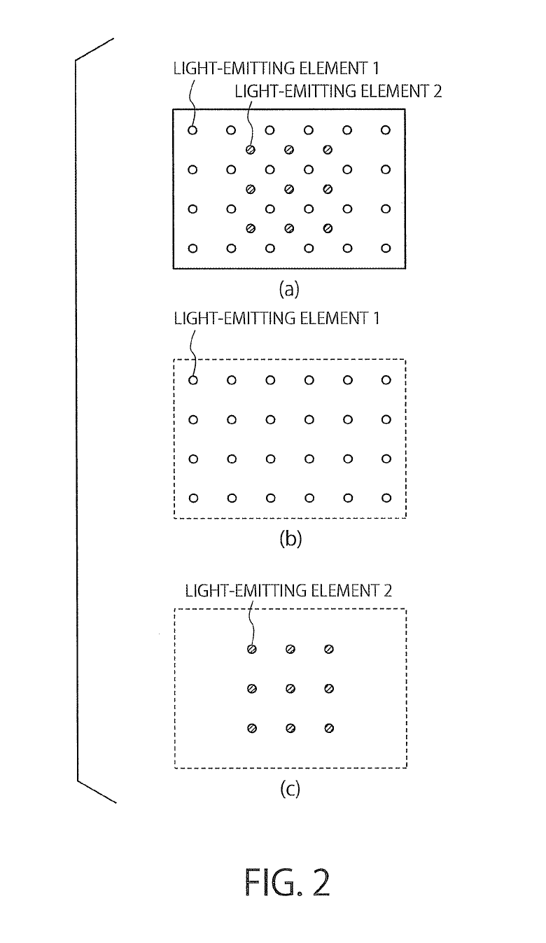

The backlight 15 according to this embodiment includes a light source unit that includes a light source unit 1 having at least one light-emitting element 1, and a light source unit 2 having at least one light-emitting element 2. FIG. 2(a) illustrates a configuration example of the backlight 15 according to this embodiment. FIG. 2(a) illustrates that the set of the light-emitting elements 1 corresponds to the light source unit 1, and the set of the light-emitting elements 2 corresponds to the light source unit 2. FIGS. 2(b) illustrates that the light source unit 1 in the backlight 15 illustrated in FIG. 2(a) is taken out, and FIG. 2(c) illustrates that the light source unit 2 in the backlight 15 illustrated in FIG. 2(a) is taken out. The light source unit 1 is correspondingly arranged on the entire surface of the panel and is configured to uniformly radiate light onto the entire surface. As illustrated in FIG. 2(b), the light source unit 2 is correspondingly arranged at the center of the panel and is configured to radiate light onto the central region. The light source unit 1 (FIG. 2(b)) and the light source unit 2 (FIG. 2(c)) light strongly or weakly for each light source according to the control of the backlight control unit 12, and radiate light onto the liquid crystal panel 14 from the back surface thereof.

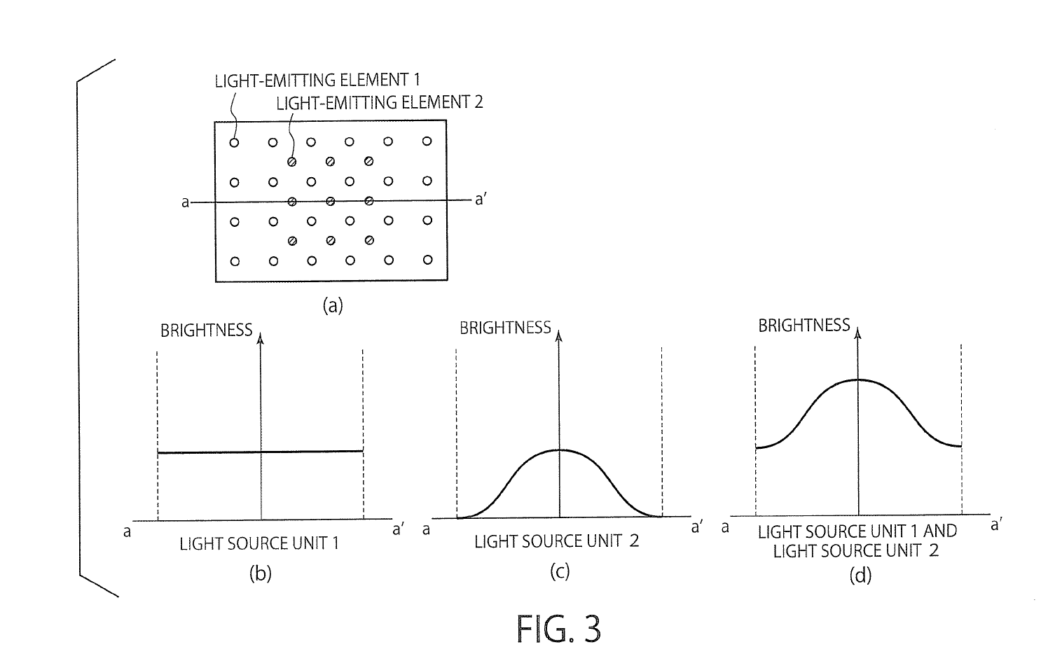

FIGS. 3(a) to 3(e) illustrate a distribution of brightness of light incident on the liquid crystal panel taken along the line a-a′ when the backlight illustrated in FIGS. 2(a) to 2(c). FIG. 3(a) illustrates a case where only the light source unit 1 is caused to emit light. FIG. 3(b) illustrates a case where only the light source unit 2 is caused to emit light. FIG. 3(c) illustrates a case where both the light source unit 1 and the light source unit 2 are caused to emit light. As illustrated in FIG. 3(a), when only the light source unit 1 is caused to emit light, a uniform brightness distribution over the entire area can be obtained. As illustrated in FIG. 3(b), when only the light source unit 2 is caused to emit light, a non-uniform distribution is obtained in which the brightness at the center is large and the brightness in the periphery is low. As illustrated in FIG. 3(c), when both the light source unit 1 and the light source unit 2 are caused to emit light, a distribution in which the distribution illustrated in FIG. 3(a) and the distribution illustrated in FIG. 3(b) are combined is obtained.

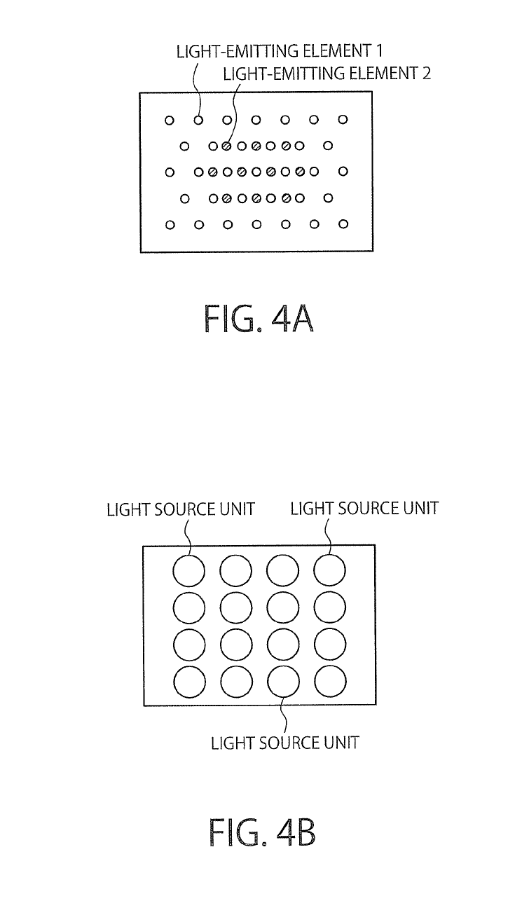

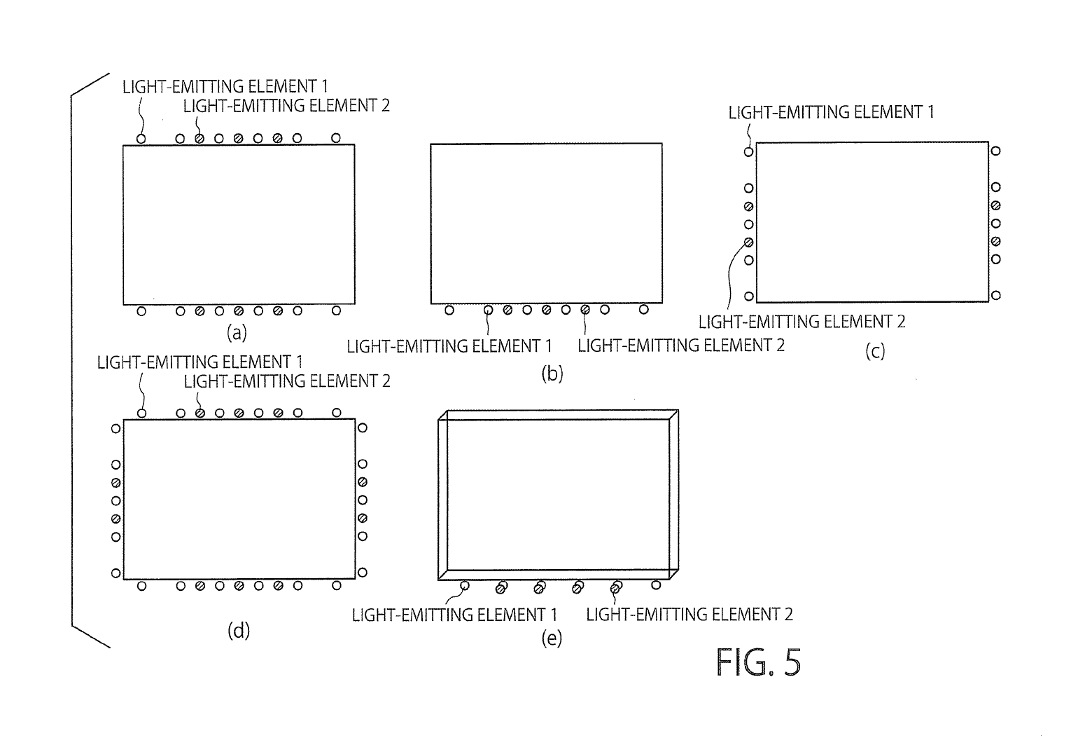

FIGS. 4A and 5 illustrate another specific configuration example of the backlight 15 according to this embodiment. FIG. 4A illustrates a configuration example of a direct backlight. FIGS. 5(a) to 5(e) illustrate configuration examples of an edge backlight. As illustrated in these figures, the backlight 15 according to this embodiment includes the light source unit 1 having at least one light-emitting element 1, and the light source unit 2 having at least one light-emitting element 2. The arrangement of the light sources may be a direct type in which the light sources are arranged on the back surface of the liquid crystal panel 14 as illustrated in FIGS. 2(a) to 2(c) and 4A, or may be an edge light type in which the light sources are arranged on an edge of the liquid crystal panel 14 and a light guide plate or a reflector (not illustrated) guides light to the back surface of the liquid crystal panel 14 to thereby radiate light onto the liquid crystal panel 14 from the back surface as illustrated in FIGS. 5(a) to 5(e). In FIGS. 5(a) to 5(e), the set of the light-emitting elements 1 corresponds to the light source unit 1, and the set of the light-emitting elements 2 corresponds to the light source unit 2. In both the direct backlight and the edge backlight, the light source unit 1 including the light-emitting elements 1 is configured to radiate light onto the entire surface of the liquid crystal panel 14, and the light source unit 2 including the light-emitting elements 2 is configured to radiate light onto the central region of the liquid crystal panel 14. In the examples of FIGS. 2(a) to 2(c), 4A, 5(a) to 5(e), the number of the light source units are two, but three or more light source units can be used. For example, the configuration as illustrated in FIG. 4B can also be employed. Each light source unit includes at least one light-emitting element, and the emission luminance of each light source units can be controlled separately. When each light source unit is caused to light with the same emission luminance, for example, the uniform brightness distribution as illustrated in FIG. 3(a) can be obtained. When the brightness of the surrounding emission light sources is decreased in this state, the non-uniform brightness distribution in which the brightness at the center is increased as illustrated in FIG. 3(c) can also be obtained. Since a number of driving circuits corresponding to the number of surrounding light sources are required, the configurations illustrated in FIGS. 2(a) to 2(c), 4A, and 5(a) to 5(e) are advantageous in terms of the low circuit area and lower power consumption. The configurations illustrated in FIGS. 2(a) to 2(c), 4A, and 5(a) to 5(e) are assumed below.

An LED, a cold-cathode tube, a hot-cathode tube, or the like is suitably used as each light-emitting element. In particular, the LED is preferably used as a light-emitting element, because the LED has a wide range in maximum emission luminance and minimum emission luminance and is capable of emission control within a high dynamic range. The emission intensity (emission luminance) and emission timing of each light source can be controlled by the backlight control unit 12.

Backlight Control Unit 12

The backlight control unit 12 causes each light source unit, which constitutes the backlight 15, to light strongly or weakly based on the emission intensity of each light source unit which is calculated by the emission intensity calculation unit 11. The backlight control unit 12 can separately control the emission intensity (emission luminance) and emission timing of each light source unit constituting the backlight 15. Each light-emitting element 1 constituting the light source unit 1 emits light with same strength, and each light-emitting element 2 constituting the light source unit 2 emits light with same strength.

Liquid Crystal Panel 14 and Liquid Crystal Control Unit 13

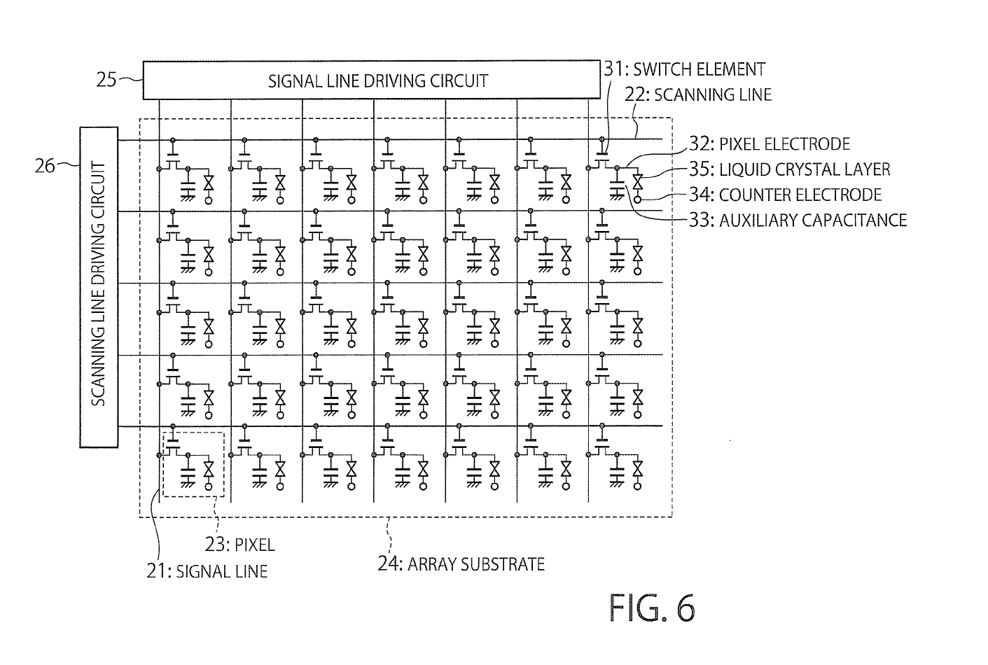

The liquid crystal panel 14 is an active matrix type in this embodiment. A plurality of signal lines 21 and a plurality of scanning lines 22, which intersect the signal lines 21, are arranged on an array substrate 24 through an insulation film, which is not illustrated, as illustrated in FIG. 6. Pixels 23 are formed in regions formed between the both intersecting lines. A signal line driving circuit 25 and a scanning line driving circuit 26 are connected to each end of the signal lines 21 and each end of the scanning line 22. Each pixel 23 includes a switch element 31 having a thin-film transistor (TFT), a pixel electrode 32, a liquid crystal layer 35, an auxiliary capacitance 33, and a counter electrode 34. The counter electrode 34 is a common electrode with respect to all the pixels 23.

The switch element 31 is the switch element 31 for writing an image signal. The gate of the switch element 31 is commonly connected to the scanning lines 22 for each horizontal line. The source of the switch element 31 is commonly connected to the signal lines 21 for each vertical line. The drain of the switch element 31 is connected to the pixel electrode 32 and is also connected to the auxiliary capacitance 33 which is electrically arranged in parallel with the pixel electrode 32.

The pixel electrode 32 is formed on the array substrate 24. The counter electrode 34, which is electrically opposite to the pixel electrode 32, is formed on a counter substrate (not illustrated). A predetermined counter voltage is applied to the counter electrode 34 from a counter voltage generation circuit (not illustrated). The liquid crystal layer 35 is held between the pixel electrode 32 and the counter electrode 34, and the fringe of the array substrate 24 and the above-mentioned counter substrate is sealed with a seal material. Any liquid crystal material may be used for the liquid crystal layer 35, but liquid crystal of a ferroelectric liquid crystal, OCB (Optically Compensated Bend) mode, or the like is suitably used as a liquid crystal material.

The scanning line driving circuit 26 is composed of a shift register, a level shifter, a buffer circuit, and the like (not illustrated). This scanning line driving circuit 26 outputs a row selection signal to each scanning line 22 based on a vertical start signal and a vertical clock signal which are output as control signals from a display ratio control unit (not illustrated).

The signal line driving circuit 25 includes an analog switch, a shift register, a sample hold circuit, a video bus, and the like, which are not illustrated. This signal line driving circuit 25 receives a horizontal start signal and a horizontal clock signal, which are output as control signals from the display ratio control unit (not illustrated), and also receives an image signal.

The liquid crystal control unit 13 according to this embodiment controls the liquid crystal panel 14 according to the input video signal such that each pixel 23 of the liquid crystal panel 14 reaches a desired amount of transmitted light.

### Emission Intensity Calculation Unit 11

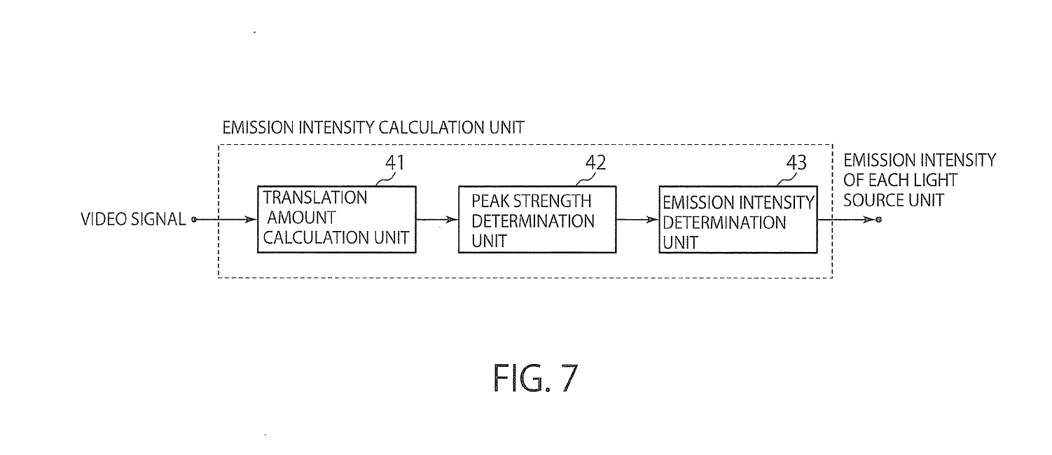

The emission intensity calculation unit 11 calculates the emission intensity of each light source suitable for display from the input video signal. FIG. 7 illustrates a configuration example of the emission intensity calculation unit 11. The emission intensity calculation unit 11 of this embodiment includes a translation amount calculation unit 41, a peak strength determination unit 42, and an emission intensity determination unit 43.

The translation amount calculation unit 41 calculates the magnitude of the translational motion (the translation amount or the amount of motion), which is included in a video obtained when display is performed according to the input video signal (hereinafter referred to as “input video”), from the input video signal.

The peak strength determination unit 42 according to this embodiment calculates the emission intensity of the light source unit 2, which is included in the backlight 15, from the translation amount calculated by the translation amount calculation unit 41.

The emission intensity determination unit 43 according to this embodiment calculates the emission intensity of each light source unit based on the emission intensity of the light source unit 2, which is calculated by the peak strength determination unit 42 according to this embodiment, and the reference emission intensity.

Each unit of the emission intensity calculation unit 11 will be described in detail below.

The translation amount calculation unit 41 calculates the translation amount of the input video from the input video signal.

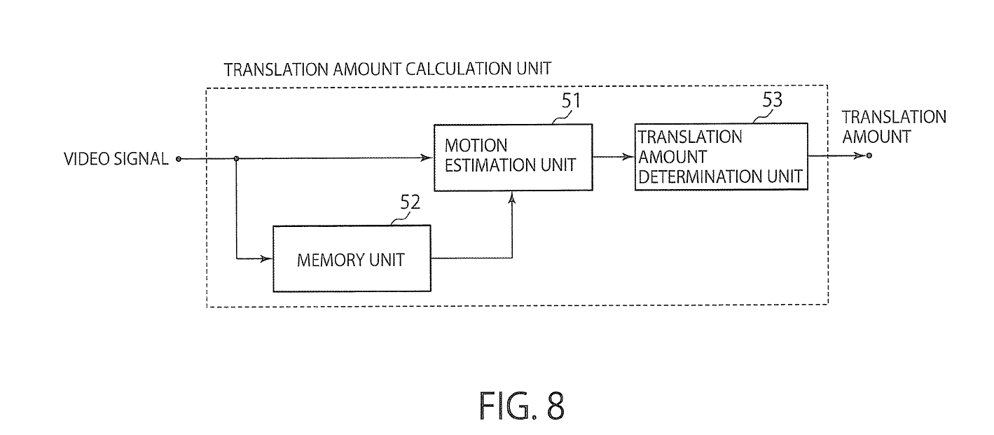

FIG. 8 illustrates the configuration of the translation amount calculation unit 41 according to this embodiment. The translation amount calculation unit 41 according to this embodiment includes a memory unit 52, a motion estimation unit 51, and a translation amount determination unit 53. The memory unit 52 according to this embodiment holds the video signal corresponding to one frame for one frame period, delays the held video signal by one frame period, and outputs the video signal to the motion estimation unit 51. That is, the video signal input from the memory unit 52 to the motion estimation unit 51 is the video signal which is delayed by one frame period with respect to the video signal input to the translation amount calculation unit 41. That is, the memory unit 52 outputs the video signal in the previous frame of the video signal input to the translation amount calculation unit 41. The motion estimation unit 51 performs motion estimation based on the video signal input to the translation amount calculation unit 41 and the video signal received from the memory unit 52. The translation amount determination unit 53 calculates the translation amount of the input video based on the estimated value of the motion calculated by the motion estimation unit 51. While this embodiment illustrates an example in which processing is performed for each one frame, but a configuration in which processing is performed for each field may also be employed.

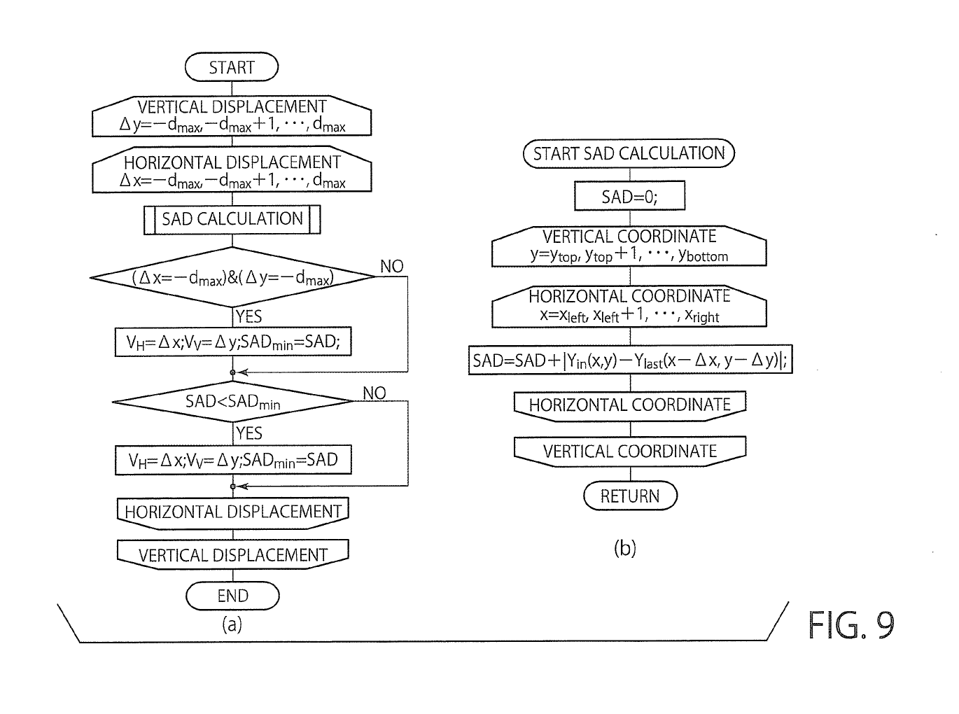

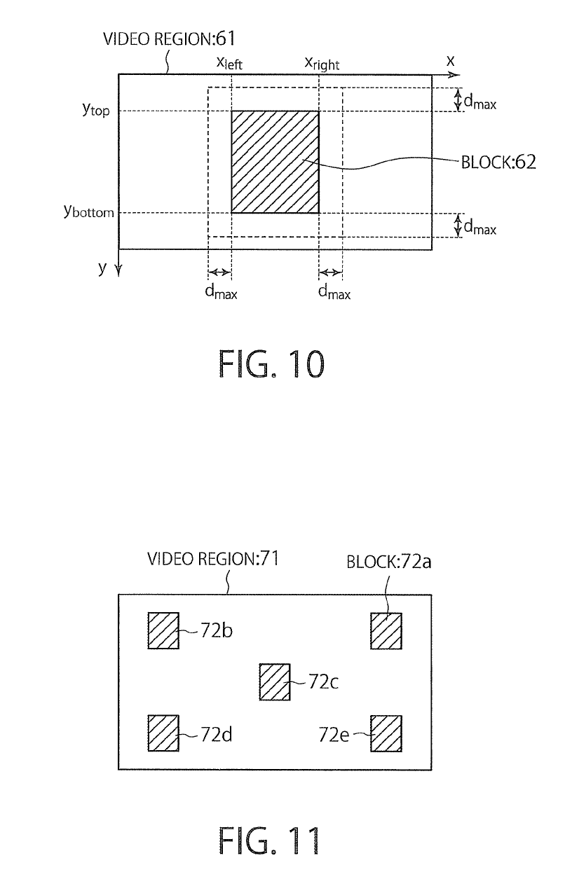

The motion estimation unit 51 performs motion estimation based on the video signal input to the translation amount calculation unit 41 and the video signal received from the memory unit 52. FIGS. 9(a) and 9(b) illustrate an example of the motion estimation in the motion estimation unit 51. FIGS. 9(a) and 9(b) illustrate an example in which a motion of an image in a block 62 of an arbitrary region in a video region 61 illustrated in FIG. 10 is estimated by block matching of a search range d_{MAX}. The block 62 is set at an arbitrary position in the frame of the video signal. The operation as illustrated in the flow of FIG. 9(a) is carried out to obtain a displacement (V_{H}, V_{V}) at which the SAD (Sum of Absolute Difference) is minimum. That is, the displacement (V_{H}, V_{V}) in the case where the SAD of the block 62 is minimum is obtained within the range of the upper, lower, right, and left d_{MAX} with respect to the block 62. FIG. 9(b) illustrates a detailed flow of “SAD calculation” of FIG. 9(a). In FIG. 9(b), Yᵢₙ(x, y) represents the luminance signal value at the coordinate (x, y) of the video signal input to the translation amount calculation unit 41, and Y (represents the luminance signal value at the coordinate (x, y) of the video signal received from the memory unit 52. The SAD represents a value indicating a degree of mismatch between videos of two frames. The displacement (V_{H}, V_{V}) at which the SAD calculated by the operation in the flow of FIG. 9(a) is minimum represents the estimated value of the motion between the videos of two frames.

This embodiment illustrates the block matching using the minimum sum of absolute difference as a matching reference, by way of example. Alternatively, a configuration in which a well-known matching reference, such as a minimum sum of square error or a maximum matching pel count, is used as a matching reference in place of the minimum sum of absolute difference may also be used. This embodiment also illustrates the motion estimation by block matching, by way of example. Alternatively, a well-known motion estimation technique, such as Optical Flow Method or Pel-Recursive Method, may be used in place of the motion estimation technique for the motion estimation unit 51 described in this embodiment (see A. Murat Telkalp, “Digital Video Processing,” Prentice Hall PTR). The motion estimation unit 51 may be configured to calculate a difference of video signals at the same pixel position between videos of two frames, and performs calculation such that the difference is decreased as the motion becomes smaller.

In the motion estimation unit 51, the position and number (the block position and number in the case of block matching) for motion estimation are not limited to the example illustrated in FIG. 10. For example, as illustrated in FIG. 11, a configuration for performing motion estimation on each of a plurality of positions (a plurality of block positions in the case of block matching) within the video region. In this case, for example, a representative value (average value, central value, weighted average value, etc.) of the estimated value of the motion calculated with respect to a plurality of positions may be used as the estimation value of the motion calculated by the motion estimation unit 51.

Further, the motion estimation unit 51 may also be configured to perform video size conversion processing on the input video signal and perform motion estimation using the video signal subjected to size conversion.

The translation amount determination unit 53 calculates the translation amount of the input video based on the estimated value of the motion calculated by the motion estimation unit 51. For example, the translation amount determination unit 53 according to this embodiment performs calculation using a value having a larger absolute value out of a horizontal component V_{H} and a vertical component V_{V} of the estimated value (V_{H}, V_{V}) of the motion as the translation amount V of the input video. That is, for example, the translation amount determination unit 53 according to this embodiment calculates the translation amount V of the input video as in Formula (1) below.

V=max(|V_{H}|,|V_{V}|) (1)

In Formula (1), max(a, b) represents an operation for calculating a larger one of the values “a” and “b”.

Alternatively, the translation amount determination unit 53 according to this embodiment calculates the magnitude of the estimated value (V_{H}, V_{V}) of the motion as the translation amount V of the input video. That is, the translation amount determination unit 53 according to this embodiment calculates the translation amount V of the input video as in Formula (2) below, for example.

V=\sqrt{V_{H}²+V_{V}²} (2)

As described above, the translation amount calculation unit 41 calculates the translation amount of the input video from the input video signal.

Alternatively, the translation amount determination unit 53 may calculate the translation amount of the input video such that each of the horizontal component V_{H} and the vertical component V_{V} of the estimated value (V_{H}, V_{V}) of the motion is multiplied by each weight coefficient, and a value having a larger absolute value out of the calculated values is used as the translation amount V of the input video, as in Formula (1′).

Alternatively, as shown in Formula (2′), the translation amount of the input video may be calculated such that the magnitude of the estimated value of the motion obtained by multiplying each of the horizontal component V_{H} and the vertical component V_{V} of the estimated values (V_{H}, V_{V}) of the motion by each weight coefficient is used as the translation amount V of the input video. In Formula (1′) and Formula (2′), w_{VH} and w_{VV} respectively represent the weights of the estimated values (V_{H}, V_{V}) of each motion with respect to the horizontal component V_{H} and the vertical component V_{V}.

V=max(w_{VH}·|V_{H}|,w_{VV}·|V_{V}|) (1′)

V=\sqrt{w_{VH}·V_{H}²+w_{VV}·V_{V}²}(2′)

For example, in the liquid crystal display device using the edge backlight as illustrated in FIG. 5(a), the unevenness in the horizontal direction is liable to occur. The visibility of the unevenness is more likely to be affected by the horizontal component of the translation amount of the input video, and is less likely to be affected by the vertical component of the translation amount of the input video. Accordingly, in the liquid crystal display device using the backlight in which the unevenness in the horizontal direction as illustrated in FIG. 5(a) is liable to occur, the weight with respect to the horizontal component, which is more likely to be affected by the visibility of the unevenness, may be preferably increased, and the weight with respect to the vertical component, which is less likely to be affected by the visibility of the unevenness, may be preferably decreased, in the translation amount of the input vide.

That is, in the translation amount determination unit 53 having the configuration as described above, the weight with respect to the component in the direction parallel to the direction in which the unevenness of the backlight is liable to occur may be preferably increased, and the weight with respect to the component in the direction perpendicular to the direction in which the unevenness of the backlight is liable to occur may be preferably decreased, in the translation amount of the input video.

The peak strength determination unit 42 according to this embodiment calculates the emission intensity of the light source unit 2, which is included in the backlight 15, from the translation amount calculated by the translation amount calculation unit 41.

The peak strength determination unit 42 according to this embodiment calculates the emission intensity of the light source unit 2 such that the emission intensity of the light source unit 2 decreases as the translation amount (that is, the magnitude of the translational motion included in the input video) calculated by the translation amount calculation unit 41 increases.

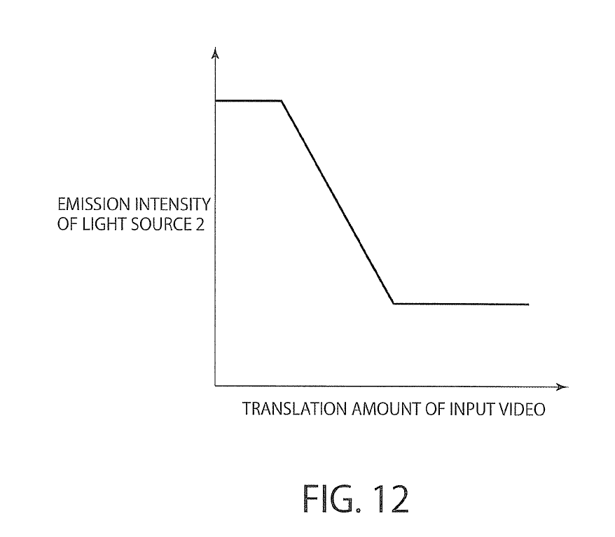

For example, the calculation of the emission intensity of the light source unit 2 in the peak strength determination unit 42 according to this embodiment can be performed by the LUT (look-up table) in which the translation amount calculated by the translation amount calculation unit 41 is set as the input value and the emission intensity of the light source unit 2 is set as the output value. FIG. 12 illustrates an example of input and output relations of the LUT in this case.

The emission intensity determination unit 43 according to this embodiment calculates emission intensity of each light source unit based on the emission intensity of the light source unit 2, which is calculated by the peak strength determination unit 42 according to this embodiment, and on the reference emission intensity.

The emission intensity determination unit 43 according to this embodiment calculates the emission intensity of the light source unit 2, which is calculated by the peak strength determination unit 42 according to this embodiment, as the emission intensity of the light source unit 2, and calculates the preset emission intensity (reference emission intensity) as the emission intensity of the light source unit 1, for example. With this configuration, as the magnitude of the translational motion included in the input video increases, the absolute emission intensity of the light source unit 2 is decreased. Because the unevenness is more likely to be perceived as the magnitude of the translational motion increases, for example, the perception of the unevenness is reduced when the brightness over the entire panel is set to be uniform. On the contrary, as the magnitude of the translational motion decreases, the unevenness is less likely to be perceived. Accordingly, the emission intensity of the light source unit 2 is increased to thereby increase the peak luminance. If the magnitude of the translational motion is small, even when the emission at the center of the panel is higher than that in the periphery thereof, the unevenness is less likely to be perceived, so that the display luminance can be increased.

Alternatively, the emission intensity determination unit 43 according to this embodiment calculates, as the emission intensity of the light source unit 2, the emission intensity obtained by multiplying the emission intensity of the light source unit 2, which is calculated by the peak strength determination unit 42 according to this embodiment, by the reference emission intensity, and calculates the reference emission intensity as the emission intensity of each light source unit 1. With this configuration, as the magnitude of the translational motion included in the input video increases, the relative emission intensity of the light source unit 2 with respect to the emission intensity of the light source unit 1 is decreased.

Alternatively, the reference emission intensity may be configured so as to be changeable from the outside of the emission intensity determination unit 43. With this configuration, the brightness of the entire video region can be changed depending on observer's preference or observing environments, for example.

### Second Embodiment

A liquid crystal display device according to a second embodiment differs from that of the first embodiment mainly in the configuration of the backlight.

The schematic configuration of the entire liquid crystal display device and the configurations of the backlight control unit, the liquid crystal panel, and the liquid crystal control unit of the liquid crystal display device according to the second embodiment are similar to those of the first embodiment, so the detailed description thereof is omitted.

### Backlight

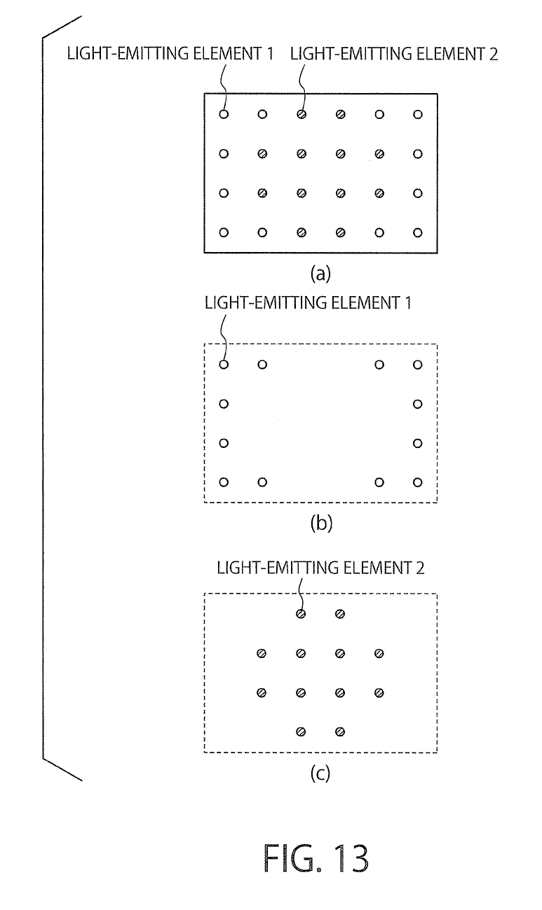

The backlight according to this embodiment includes the light source unit 1 having at least one light-emitting element 1, and the light source unit 2 having at least one light-emitting element 2. FIG. 13(a) illustrates a configuration example of the backlight according to this embodiment. FIG. 13(b) illustrates that the light source unit 1 in the backlight illustrated in FIG. 13(a) is taken out, and FIG. 13(c) illustrates that the light source unit 2 in the backlight illustrated in FIG. 13(a) is taken out. Each of these light sources lights strongly or weakly according to the control of the backlight control unit 12, and illuminates the liquid crystal panel 14 from the back surface.

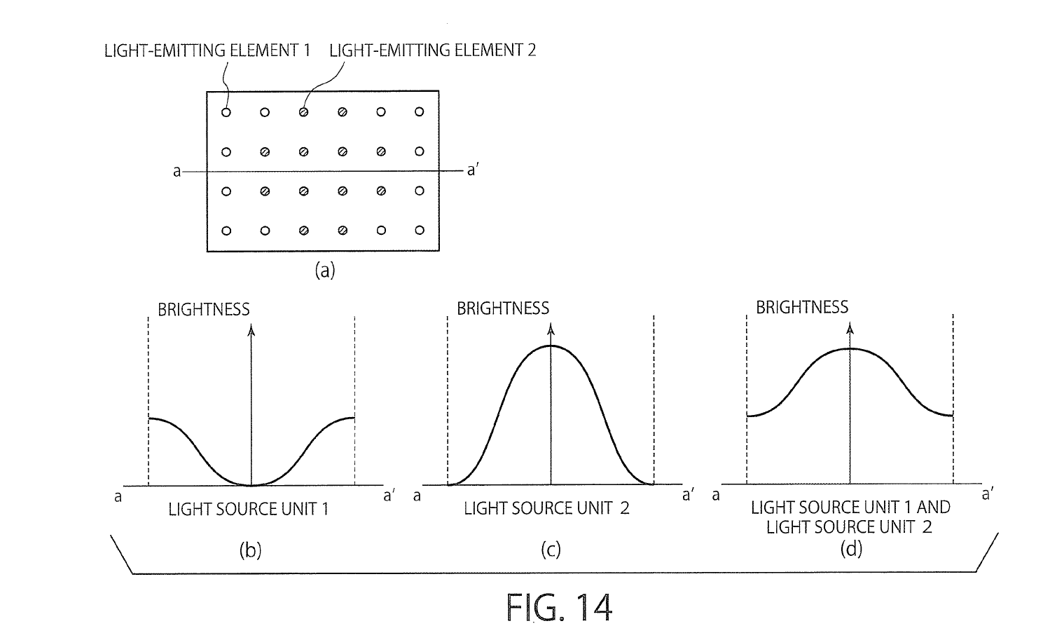

FIGS. 14(a) to 14(d) illustrate a distribution of brightness of light incident on the liquid crystal panel taken along the line a-a′ when the backlight illustrated in FIGS. 13(a) to 13(c) is used. FIG. 14(a) illustrates the case of causing only the light source unit 1 to emit light. FIG. 14(b) illustrates the case of causing only the light source unit 2 to emit light. FIG. 14(c) illustrates the case of causing both the light source unit 1 and the light source unit 2 to emit light. As illustrated in FIG. 14(a), the light source unit 1 is correspondingly arranged at both ends of the panel. When only the light source unit 1 is caused to emit light, the distribution in which the brightness at both ends is high and the brightness at the center is low is obtained. As illustrated in FIG. 14(b), when only the light source unit 2 is caused to emit light, the light source unit 2 is correspondingly arranged at the center of the panel, the brightness at the center is high and the brightness in the periphery is low. In the case of causing both the light source unit 1 and the light source unit 2 to emit light, a distribution in which the distribution of FIG. 14(a) and the distribution of FIG. 14(b) are added as illustrated in FIG. 14(c) is obtained.

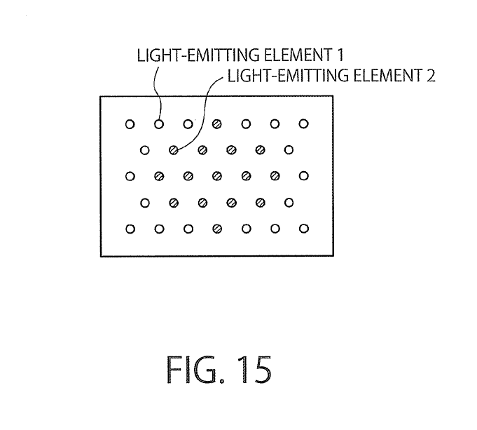

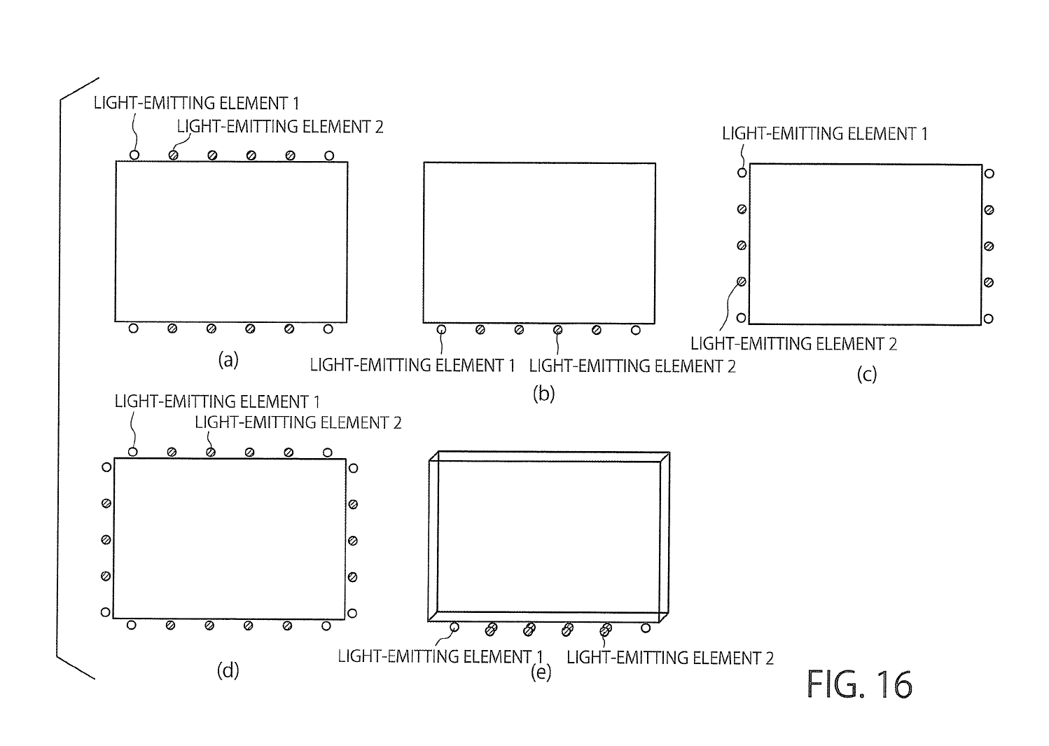

FIGS. 15 and 16 illustrate configurations of other specific examples of the backlight according to this embodiment. FIG. 15 illustrates a configuration example of the direct backlight. FIGS. 16(a) to 16(e) illustrate configuration examples of the edge backlight. As illustrated in these figures, the backlight according to this embodiment includes the light source unit 1 having at least one light-emitting element 1, and the light source unit 2 having at least one light-emitting element 2. The arrangement of the light sources may be the direct type in which the light sources are arranged on the back surface of the liquid crystal panel 14 as illustrated in FIG. 15, or may be the edge light type in which the light sources are arranged on an edge of the liquid crystal panel 14, and a light guide plate or a reflector (not illustrated) guides light to the back surface of the liquid crystal panel 14 to thereby illuminate the back surface of the liquid crystal panel 14, as illustrated in FIGS. 16(a) to 16(e). Apart from the light source units, a phosphor that is excited by light from the light sources and emits light may be arranged on the back surface of the liquid crystal panel 14. As illustrated in FIG. 4B of the first embodiment, the backlight using three or more light source units may be used.

An LED, a cold-cathode tube, a hot-cathode tube, or the like is suitably used as each light-emitting element. In particular, the LED is preferably used as a light-emitting element, because the LED has a wide range in maximum emission luminance and minimum emission luminance and is capable of emission control within a high dynamic range. A phosphor that is excited by excitation light and emits light may be used as the light-emitting element, in place of the light-emitting element. The emission intensity (emission luminance) and emission timing of each light source can be controlled by the backlight control unit 12.

### Emission Intensity Calculation Unit

The emission intensity calculation unit according to this embodiment differs from the emission intensity calculation unit according to the first embodiment mainly in that an emission intensity conversion unit is provided.

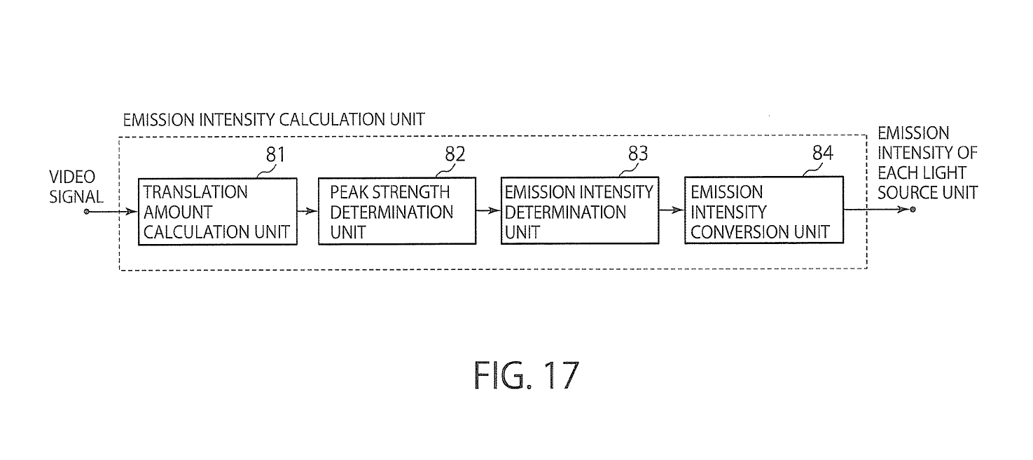

The emission intensity calculation unit according to this embodiment calculates the emission intensity of each light source unit suitable for display from the input video signal, as in the emission intensity calculation unit 11 of the first embodiment. FIG. 17 illustrates the configuration of the emission intensity calculation unit according to this embodiment. The emission intensity calculation unit of this embodiment includes a translation amount calculation unit 81, a peak strength determination unit 82, an emission intensity determination unit 83, and an emission intensity conversion unit 84.

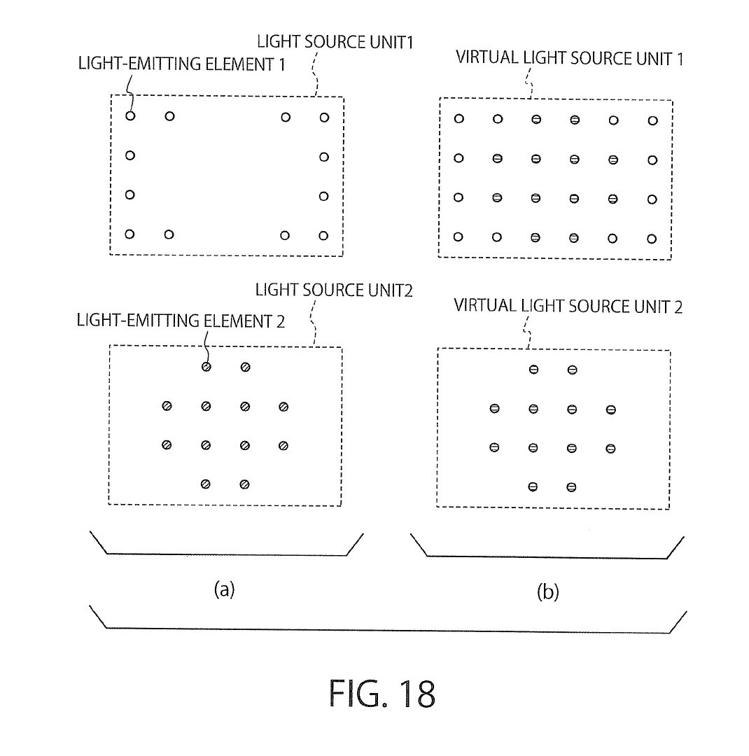

The liquid crystal display device according to this embodiment differs from that of the first embodiment in the configuration of the backlight. However, a configuration virtually similar to the backlight 15 according to the first embodiment can be achieved by devising the emission of each of the light source unit 1 and the light source unit 2. FIG. 18(a) illustrates the light source unit 1 and the light source unit 2 according to this embodiment, as in FIGS. 13(b) and 13(c). The light source unit 1 is caused to emit light and the light source unit 2 is caused to emit light with the same emission luminance as that of the light source unit 1, thereby obtaining the uniform brightness distribution over the entire panel. Thus, a virtual light source unit 1 having functions similar to those of the light source unit 1 according to the first embodiment is achieved (upper part of FIG. 18(b)). Further, the emission of the light source unit 2 is further increased in this state, thereby obtaining the non-uniform brightness distribution in which the brightness in the vicinity of the center is relatively increased. Thus, a virtual light source unit 2 having functions similar to the light source unit 2 according to the first embodiment is achieved. That is, in this embodiment, the virtual light source unit 1 in which part of the emission of the light source unit 2 is used as part of the emission of the light source unit 1 of the first embodiment, and the virtual light source unit 2 (lower part of FIG. 18(b)) in which the remaining emission of the light source unit 2 is regarded as the emission of the light source unit 2 of the first embodiment are virtually configured. Thus, the configuration of the backlight according to this embodiment can be regarded as the configuration virtually similar to the back light according to the first embodiment. The virtual light source unit 1 of this embodiment corresponds to the light source unit 1 of the first embodiment, and the virtual light source unit 2 of this embodiment corresponds to the light source unit 2 of the first embodiment.

The translation amount calculation unit 81 according to this embodiment calculates the magnitude (the translation amount or the amount of motion) of the translational motion included in the video (hereinafter referred to as “input video”) when display is performed according to the input video signal, based on the input video signal as in the translation amount calculation unit according to the first embodiment. The peak strength determination unit 82 according to this embodiment calculates the emission intensity of the virtual light source unit 2, which is included in the backlight, from the translation amount calculated by the translation amount calculation unit 81. The emission intensity determination unit 83 according to this embodiment calculates the virtual emission intensity of each virtual light source unit based on the emission intensity of the virtual light source unit 2, which is calculated by the peak strength determination unit 82 according to this embodiment, and the reference emission intensity. The emission intensity conversion unit 84 converts the virtual emission intensity of each virtual light source unit, which is calculated by the emission intensity determination unit 83 according to this embodiment, into the emission intensity of each light source unit.

Each unit of the emission intensity calculation unit will be described in detail below. The translation amount calculation unit 81 is similar to that of the first embodiment, so the detailed description thereof is herein omitted.

The peak strength determination unit 82 according to this embodiment calculates the emission intensity of the virtual light source unit 2, which is included in the backlight, from the translation amount calculated by the translation amount calculation unit 81. The peak strength determination unit 82 according to this embodiment may have the same configuration as that of the peak strength determination unit according to the first embodiment, and calculates the emission intensity of the virtual light source unit 2 in place of the emission intensity of the light source unit 2 according to the first embodiment. Accordingly, the peak strength determination unit 82 according to this embodiment calculates the emission intensity of the virtual light source unit 2 such that the emission intensity of the virtual light source unit 2 is decreased as the translation amount (that is, the magnitude of the translational motion included in the input video) calculated by the translation amount calculation unit 81 is increased.

The emission intensity determination unit 83 according to this embodiment calculates the virtual emission intensity of each virtual light source unit based on the emission intensity of the virtual light source unit 2, which is calculated by the peak strength determination unit 82 according to this embodiment, and the reference emission intensity. The emission intensity determination unit 83 according to this embodiment may have the same configuration as that of the emission intensity determination unit according to the first embodiment.

The emission intensity conversion unit 84 converts the virtual emission intensity of each virtual light source unit, which is calculated by the emission intensity determination unit 83 according to this embodiment, into the emission intensity of each light source unit. The emission intensity conversion unit 84 calculates the value obtained by adding the emission intensity of the virtual light source unit 2 to the emission intensity of the virtual light source unit 1, as the emission intensity of the light source unit 2, and calculates the emission intensity of the virtual light source unit 1 as the emission intensity of the light source unit 1.

### Third Embodiment

A liquid crystal display device according to a third embodiment differs from that of the first embodiment in the configuration of the motion estimation unit of the translation amount calculation unit in the emission intensity calculation unit.

The schematic configuration of the entire liquid crystal display device and the configurations of the backlight, the backlight control unit, the liquid crystal panel, and the liquid crystal control unit of the liquid crystal display device according to the third embodiment are similar to those of the first embodiment, so the detailed description thereof is omitted.

### Emission Intensity Calculation Unit

The emission intensity calculation unit according to the third embodiment differs from that of the first embodiment in the configuration of the motion estimation unit of the translation amount calculation unit.

The emission intensity calculation unit according to this embodiment includes a translation amount calculation unit, a peak strength determination unit, and a emission intensity determination unit, as with the emission intensity calculation unit 11 (see FIG. 7) according to the first embodiment. Each unit associated with the emission intensity calculation unit of this embodiment will be described in detail below. The peak strength determination unit and the emission intensity determination unit of this embodiment are similar to those of the first embodiment, so the detailed description thereof is omitted.

The translation amount calculation unit according to this embodiment calculates the translation amount of the input video from the input video signal. The translation amount calculation unit according to this embodiment includes a memory unit, a motion estimation unit, and a translation amount determination unit, as with the translation amount calculation unit according to the first embodiment. The memory unit holds the video signal corresponding to one frame for one frame period, delays the held video signal by one frame period, and outputs the video signal to the motion estimation unit. The motion estimation unit performs motion estimation based on the video signal input to the translation amount calculation unit and the video signal received from the memory unit. The translation amount determination unit calculates the translation amount of the input video based on the estimated value of the motion calculated by the motion estimation unit.

The memory unit may have the same configuration as that of the memory unit according to the first embodiment, so the detailed description thereof is omitted.

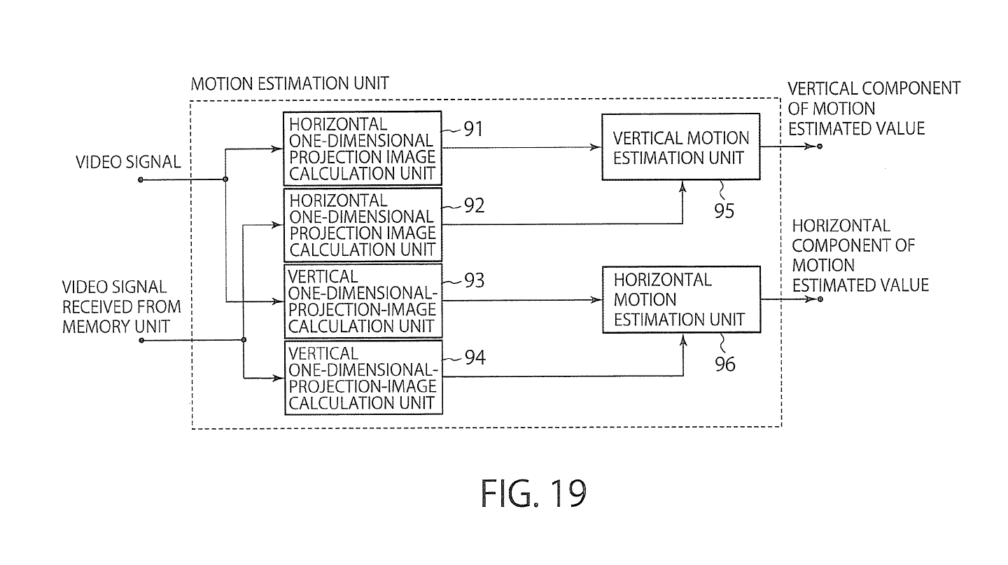

The motion estimation unit performs motion estimation based on the video signal input to the translation amount calculation unit and the video signal received from the memory unit. FIG. 19 illustrates the configuration of the motion estimation unit according to this embodiment. The motion estimation unit according to the third embodiment includes a horizontal one-dimensional-projection-image calculation unit 91 with respect to the video signal input to the translation amount calculation unit; a vertical one-dimensional-projection-image calculation unit 93 with respect to the video signal input to the translation amount calculation unit; a horizontal one-dimensional-projection-image calculation unit 92 with respect to the video signal received from the memory unit; a vertical one-dimensional-projection-image calculation unit 94 with respect to the video signal received from the memory unit; a vertical motion estimation unit 95, and a horizontal motion estimation unit 96.

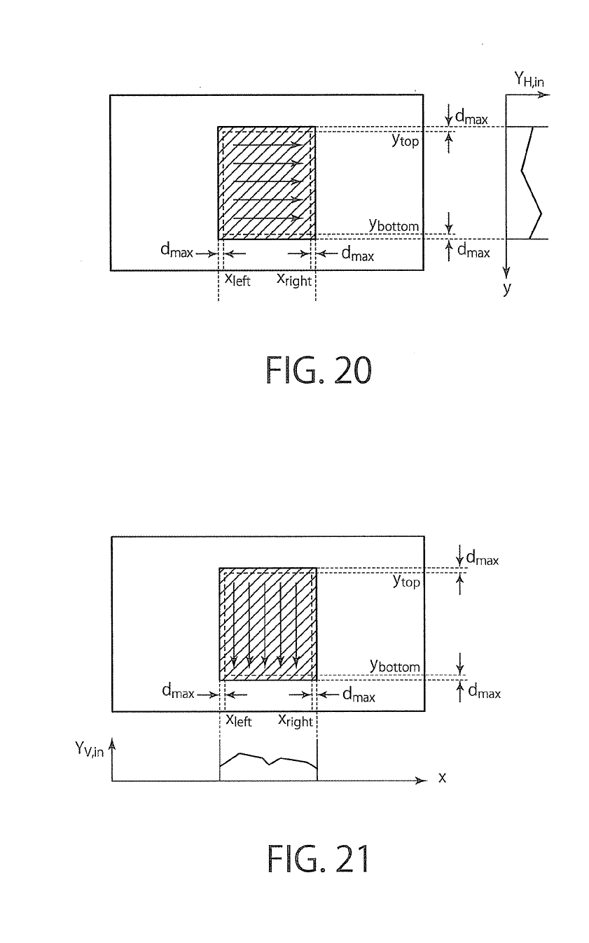

The horizontal one-dimensional-projection-image calculation unit 91 calculates a one-dimensional image by adding an input video signal at each vertical position in the horizontal direction to each vertical position of the video region. FIG. 20 schematically illustrates operation of the horizontal one-dimensional-projection-image calculation unit 91 with respect to the video signal input to the translation amount calculation unit. A range in which d_{MAX} is added to upper, lower, right, and left portions with respect to a block (a rectangular shape indicated by a dashed line) of an arbitrary region on the video is set, and a video signal is added in the horizontal direction within this range, thereby calculating a one-dimensional image. That is, the horizontal one-dimensional-projection-image calculation unit 91 for the video signal input to the translation amount calculation unit performs the operation represented by the following formula, thereby calculating the one-dimensional image obtained by adding the video signal input to the translation amount calculation unit in the horizontal direction.

$${Y}_{H , in} ( y ) = {\sum }_{x = {x}_{left} - {d}_{max}}^{{x}_{right} + {d}_{max}} \{ {Y}_{in} ( x , y ) \} \qquad ( 3 )$$

In Formula (3), Yᵢₙ(x, y) represents the luminance signal value at the coordinate (x, y) of the video signal input to the translation amount calculation unit; each of X_{left}, X_{right}, and d_{MAX} represents a preset constant; and Y_{H,in}(y) represents the value at a vertical position “y” of the one-dimensional image obtained by adding the video signal input to the translation amount calculation unit in the horizontal direction. Also the horizontal one-dimensional-projection-image calculation unit 92 for the video signal received from the memory unit calculates the one-dimensional image obtained by adding the video signal received from the memory unit in the horizontal direction. The value at the vertical position “y” of the one-dimensional image calculated by the horizontal one-dimensional-projection-image calculation unit 92 for the video signal received from the memory unit is defined as Y_{H,last} (v)

The vertical one-dimensional-projection-image calculation unit 93 calculates the one-dimensional image by adding the input video signal at each horizontal position in the vertical direction with respect to each horizontal position of the video region. FIG. 21 schematically illustrates operation of the vertical one-dimensional-projection-image calculation unit 93 with respect to the video signal input to the translation amount calculation unit. A one-dimensional image is calculated by adding a video signal in the vertical direction within a range in which d_{MAX} is added to upper, lower, right, and left portions with respect to the above-mentioned block. That is, the vertical one-dimensional-projection-image calculation unit 93 for the video signal input to the translation amount calculation unit performs the operation represented by the following formula, thereby calculating the one-dimensional image obtained by adding the video signal input to the translation amount calculation unit in the vertical direction.

$${Y}_{V , in} ( x ) = {\sum }_{y = {y}_{top} - {d}_{max}}^{{y}_{bottom} + {d}_{max}} \{ {Y}_{in} ( x , y ) \} \qquad ( 4 )$$

In Formula 4, Yᵢₙ(x, y) represents the luminance signal value at the coordinate (x, y) of the video signal input to the translation amount calculation unit; each of yₜₒₚ, X_{bottom}, d_{MAX} represents a preset constant; and Y_{V,in}(X) represents the value at a horizontal position “x” of the one-dimensional image obtained by adding the video signal input to the translation amount calculation unit in the vertical direction. Also the vertical one-dimensional-projection-image calculation unit 94 for the video signal received from the memory unit calculates the one-dimensional image obtained by adding the video signal received from the memory unit in the vertical direction. The value at the horizontal position “x” of the one-dimensional image calculated by the vertical one-dimensional-projection-image calculation unit 94 for the video signal received from the memory unit is defined as Y_{V,last}(x).

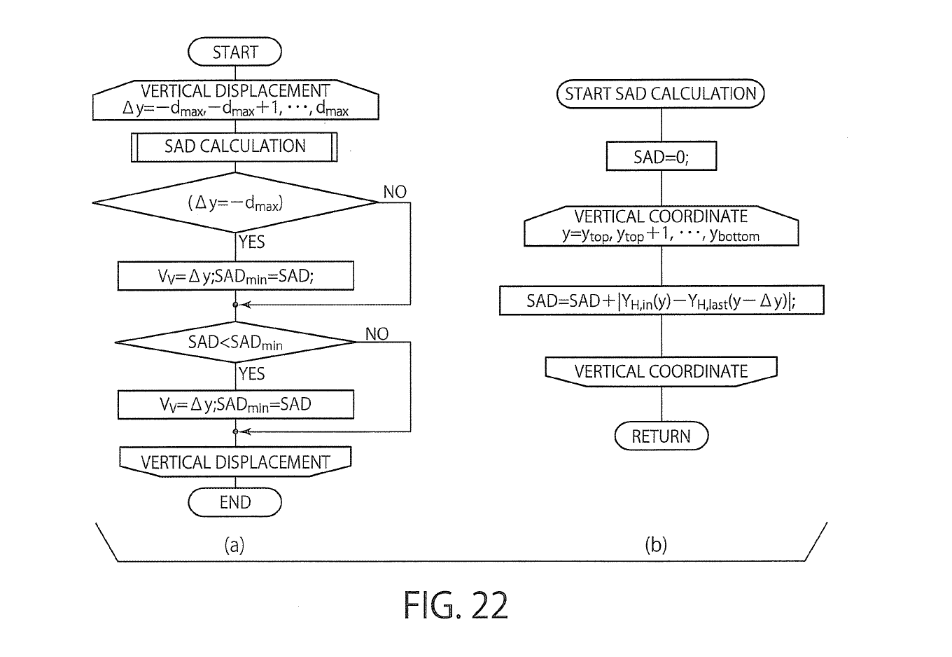

The vertical motion estimation unit 95 performs motion estimation in the vertical direction based on the one-dimensional image calculated by the horizontal one-dimensional-projection-image calculation unit 91 for the video signal input to the translation amount calculation unit, and the one-dimensional image calculated by the horizontal one-dimensional-projection-image calculation unit 92 for the video signal received from the memory unit. FIG. 22(a) illustrates an example of the motion estimation in the vertical motion estimation unit 95. FIG. 22(a) illustrates an example in which the motion in the vertical direction of the image of the block in the region illustrated in FIG. 10 is estimated by one-dimensional block matching in the search range d_{MAX}. FIG. 22(b) illustrates a detailed flow of “SAD calculation” of FIG. 22(a). In FIG. 22(b), Y_{H,in}(y) represents the value at the vertical position “y” of the one-dimensional image calculated by the horizontal one-dimensional-projection-image calculation unit 91 for the video signal input to the translation amount calculation unit; and Y_{H,last}(v) represents the value at the vertical position “y” of the one-dimensional image calculated by the horizontal one-dimensional-projection-image calculation unit 92 for the video signal input from the memory unit. The operation illustrated in FIGS. 22(a) and 22(b) is carried out to obtain the vertical displacement V_{V} at which the SAD is minimum. The SAD represents the value indicating a degree of mismatch between videos of two frames, and the displacement V_{V} at which the SAD calculated by the operation illustrated in FIGS. 22(a) and 22(b) is minimum is the vertical component of the estimated value of the motion between videos of two frames.

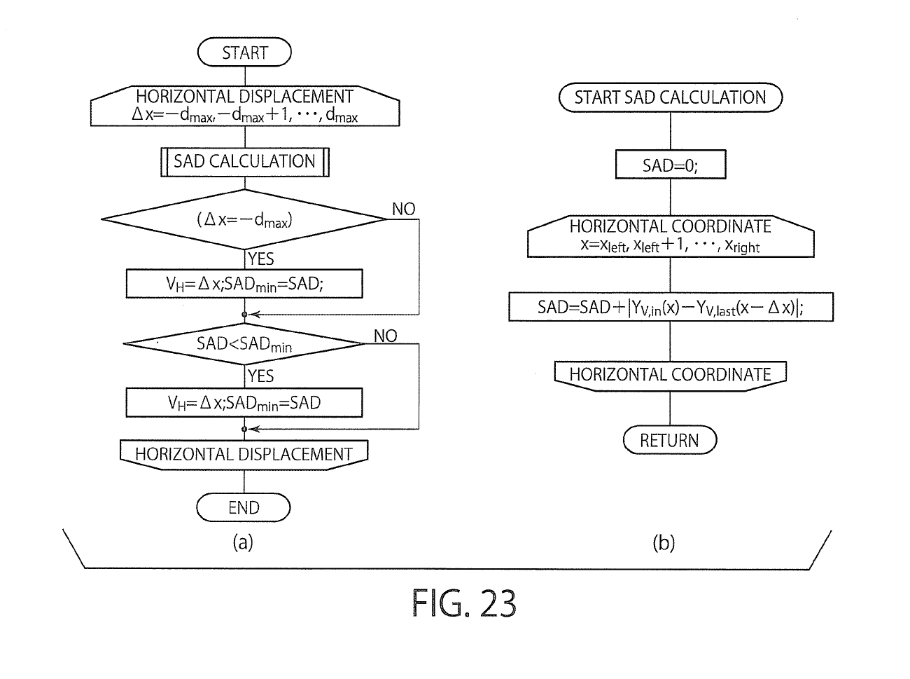

The horizontal motion estimation unit 96 performs motion estimation in the horizontal direction based on the one-dimensional image calculated by the vertical one-dimensional-projection-image calculation unit 93 for the video signal input to the translation amount calculation unit, and the one-dimensional image calculated by the vertical one-dimensional-projection-image calculation unit 94 for the video signal received from the memory unit. FIG. 23(a) illustrates an example of the motion estimation in the horizontal motion estimation unit 96. FIG. 23(a) illustrates an example in which the motion in the horizontal direction of the image of the block in the region illustrated in FIG. 10 by one-dimensional block matching within the search range d_{MAX}. FIG. 23(b) illustrates a detailed flow of “SAD calculation” illustrated in FIG. 23(a). In FIG. 23(b), Y_{V,in}(x) represents the value at the horizontal position “x” of the one-dimensional image calculated by the vertical one-dimensional-projection-image calculation unit 93 for the video signal input to the translation amount calculation unit, and Y_{V,last}(x) represents the value at the horizontal position “y” of the one-dimensional image calculated by the vertical one-dimensional-projection-image calculation unit 94 for the video signal received from the memory unit. The operation illustrated in FIG. 23 is carried out to obtain the horizontal displacement V_{H} at which the SAD is minimum. The SAD represents the value indicating a degree of mismatch between videos of two frames, and the displacement V_{H} at which the SAD calculated by the operation as illustrated in FIG. 23 is minimum represents the horizontal component of the estimated value of the motion between videos of two frames.

The motion estimation unit according to this embodiment calculates the estimated values (V_{H}, V_{V}) of the motion between videos of two frames.

The translation amount determination unit may have the same configuration as that of the translation amount determination unit according to the first embodiment, so the detailed description thereof is omitted.

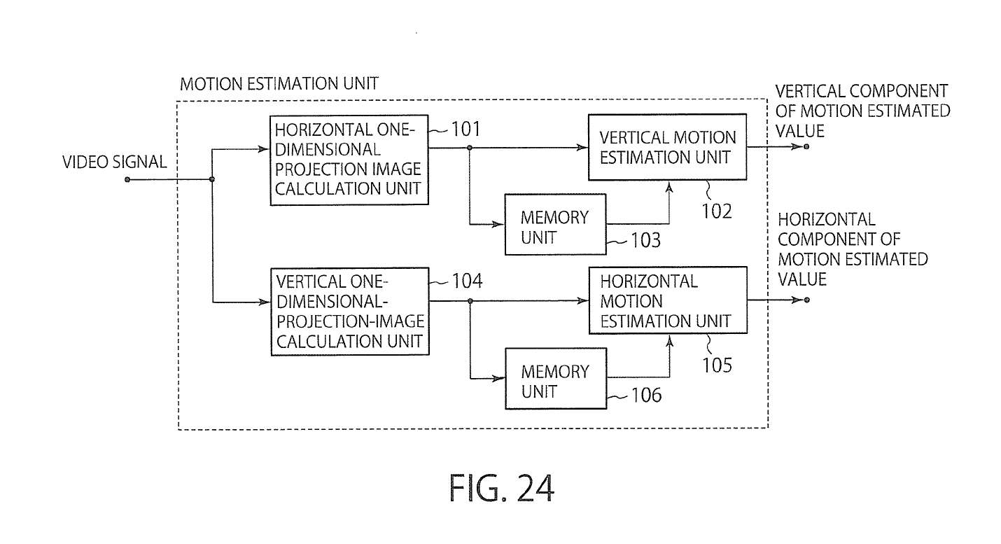

The translation amount calculation unit may have a configuration in which the memory unit is provided in the motion estimation unit. FIG. 24 illustrates the configuration of the motion estimation unit in this case. The memory unit in this case holds the one-dimensional image corresponding to one frame for one frame period, delays the held one-dimensional image by one frame period, and outputs the one-dimensional image to the motion estimation unit. The vertical motion estimation unit 102 performs motion estimation in the vertical direction in the manner as in the vertical motion estimation unit 95 described above, based on the one-dimensional image calculated by the horizontal one-dimensional-projection-image calculation unit 101, and the one-dimensional image which is obtained by delaying the one-dimensional image by one frame period by the memory unit 103 and which is input to the vertical motion estimation unit 102. The horizontal motion estimation unit 105 performs motion estimation in the horizontal direction in the same manner as in the horizontal motion estimation unit 96 described above, based on the one-dimensional image calculated by the vertical one-dimensional-projection-image calculation unit 104, and the one-dimensional image which is obtained by delaying the one-dimensional image by one frame period by the memory unit 106 and which is input to the horizontal motion estimation unit 105.

The peak strength determination unit may have the same configuration as that of the peak strength determination unit of the first embodiment, so the detailed description thereof is omitted.

The emission intensity determination unit may have the same configuration as that of the emission intensity determination unit of the first embodiment, so the detailed description thereof is omitted.

### Fourth Embodiment

A liquid crystal display device according to a fourth embodiment differs from that of the first and second embodiments in that the emission intensity calculation unit includes a brightness calculation unit.

The schematic configuration of the entire liquid crystal display device and the configurations of the backlight, the backlight control unit, the liquid crystal panel, and the liquid crystal control unit of the liquid crystal display device according to the fourth embodiment are similar to those of the first embodiment, so the detailed description thereof is omitted.

### Emission Intensity Calculation Unit

The emission intensity calculation unit according to the fourth embodiment greatly differs from the emission intensity calculation unit of the first embodiment in that the brightness calculation unit is provided.

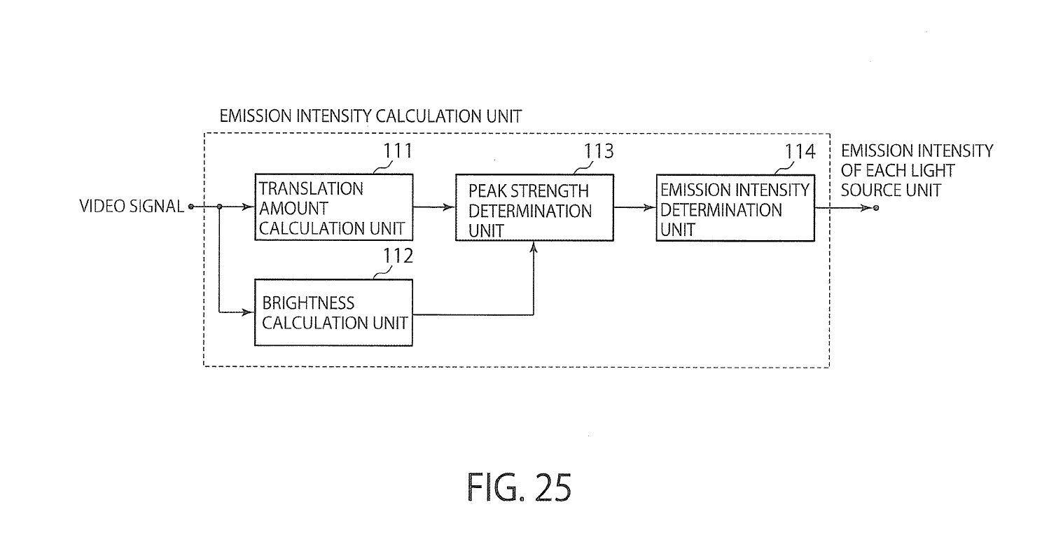

FIG. 25 illustrates the configuration of the emission intensity calculation unit according to this embodiment. The translation amount calculation unit and the emission intensity determination unit are similar to those of the first embodiment, so the detailed description thereof is omitted.

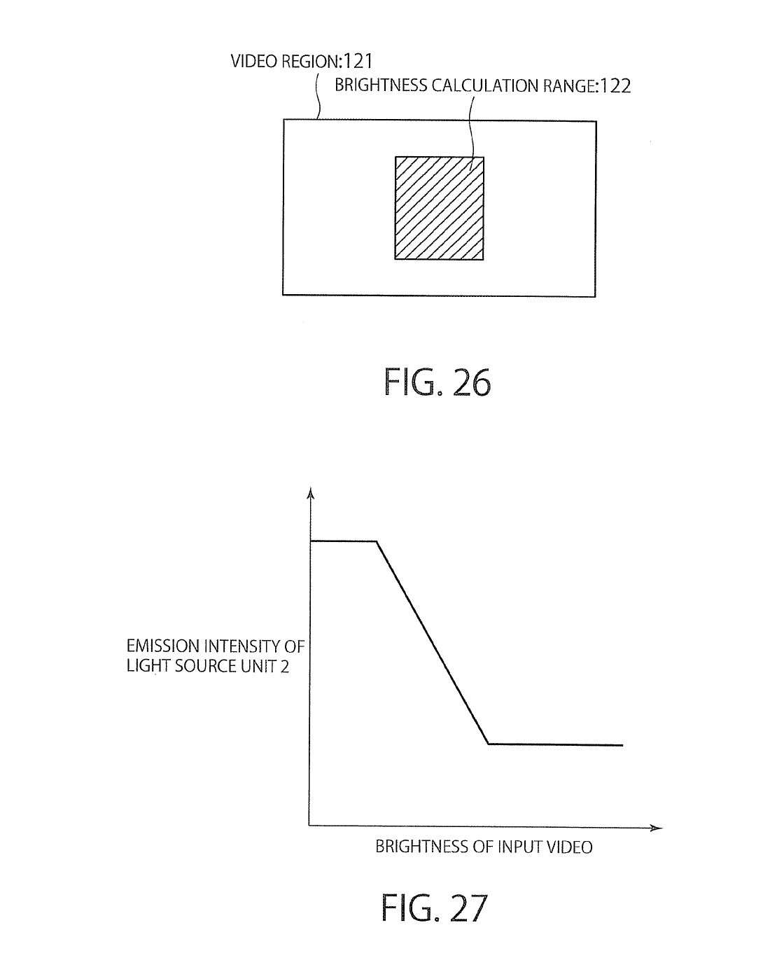

The brightness calculation unit 112 calculates the brightness of the input video from the input video signal. The brightness calculation unit 112 calculates, as the brightness of the input video, the total of luminance signal values within a brightness calculation range 122 in a video region 121 as illustrated in FIG. 26, for example.

The peak strength determination unit 113 according to this embodiment calculates the emission intensity of the light source unit 2, which is included in the backlight, from the translation amount calculated by the translation amount calculation unit 111 and the brightness of the input video calculated by the brightness calculation unit 112.

The peak strength determination unit 113 according to this embodiment calculates the emission intensity of the light source unit 2 such as the emission intensity of the light source unit 2 decreases as the brightness of the input video calculated by the brightness calculation unit 112 increases.

For example, the calculation of the emission intensity of the light source unit 2 in the peak strength determination unit 113 according to this embodiment can be carried out using the LUT (look-up table) in which the brightness of the input video calculated by the brightness calculation unit 112 is set as the input value and the emission intensity of the light source unit 2 is set as the output value. FIG. 27 illustrates an example of input and output relations of the LUT in this case.

Alternatively, the peak strength determination unit 113 according to this embodiment may be configured to calculate the linear sum of the translation amount calculated by the translation amount calculation unit 111, and the brightness of the input video calculated by the brightness calculation unit 112, and calculate the emission intensity of the light source unit 2 by referring to the LUT (loop-up table) in which the linear sum is set as the input value and the emission intensity of the light source unit 2 is set as the output value. The linear sum LUTᵢₙ of the translation amount calculated by the translation amount calculation unit 111, and the brightness of the input video calculated by the brightness calculation unit 112 is calculated as follows, assuming that the translation amount calculated by the translation amount calculation unit 111 is represented by V, the brightness of the input video calculated by the brightness calculation unit 112 is represented by Yₜₒₜₐₗ and the preset constant is represented by k₂, for example.

LUTᵢₙ=V+k₂·Yₜₒₜₐₗ (5)

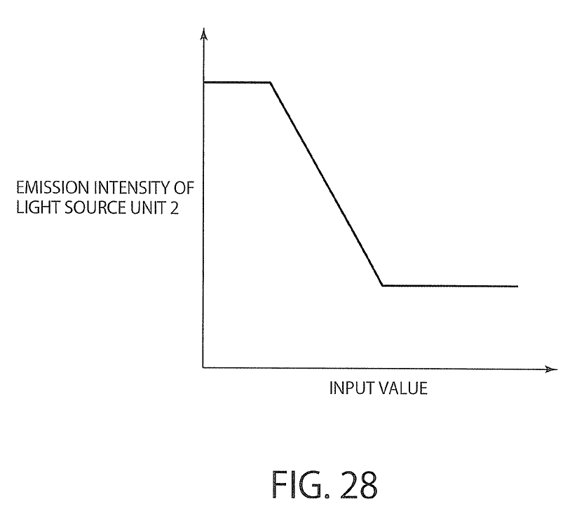

FIG. 28 illustrates an example of input and output relations of the LUT in this case. The peak strength determination unit 113 having the configuration as described above calculates the emission intensity of the light source unit 2 such that the emission intensity of the light source unit 2 decreases as the translation amount (that is, the magnitude of the translational motion included in the input video) calculated by the translation amount calculation unit 111 increase, and the emission intensity of the light source unit 2 decreases as the brightness of the input video calculated by the brightness calculation unit 112 increases.

### Fifth Embodiment

A liquid crystal display device according to a fifth embodiment differs from the first to fourth embodiments in that the emission intensity calculation unit includes a total gradient calculation unit.

The schematic configuration of the entire liquid crystal display device and the configurations of the backlight, the backlight control unit, the liquid crystal panel, and the liquid crystal control unit of the liquid crystal display device according to the fourth embodiment are similar to those of the first embodiment, so the detailed description thereof is omitted.

### Emission Intensity Calculation Unit

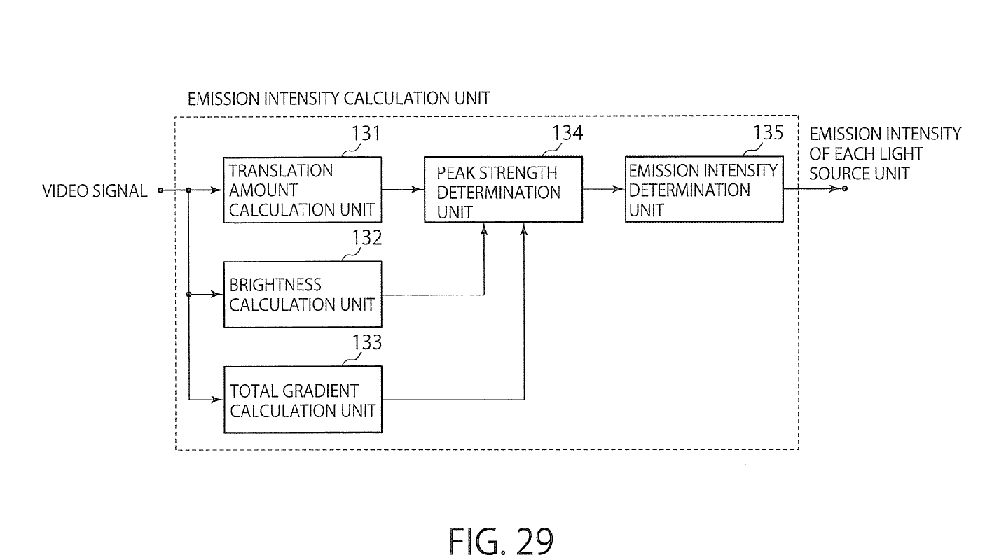

The emission intensity calculation unit according to the fifth embodiment greatly differs from the emission intensity calculation units according to the first and fourth embodiments in that the total gradient calculation unit is provided. FIG. 29 illustrates the configuration of the emission intensity calculation unit according to this embodiment. The translation amount calculation unit 131 and the emission intensity determination unit 135 are similar to those of the first embodiment, so the detailed description thereof is omitted.

The total gradient calculation unit 133 calculates the total amount of the gradient (hereinafter referred to as “total gradient”) of the input video from the input video signal.

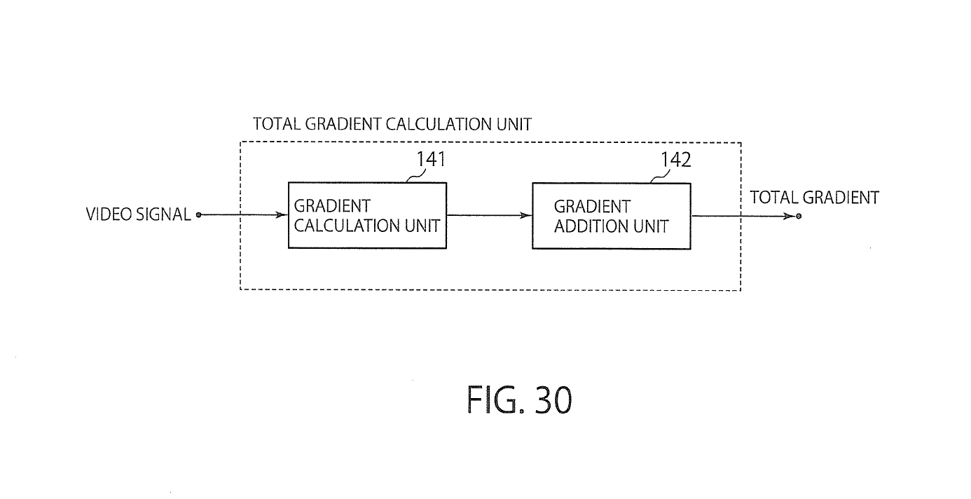

FIG. 30 illustrates the configuration of the total gradient calculation unit 133. The total gradient calculation unit includes, for example, a gradient calculation unit 141 and a gradient addition unit 142.

The gradient calculation unit 141 calculates the magnitude of the luminance gradient of the input video with respect to each pixel position of the video region from the input video signal.

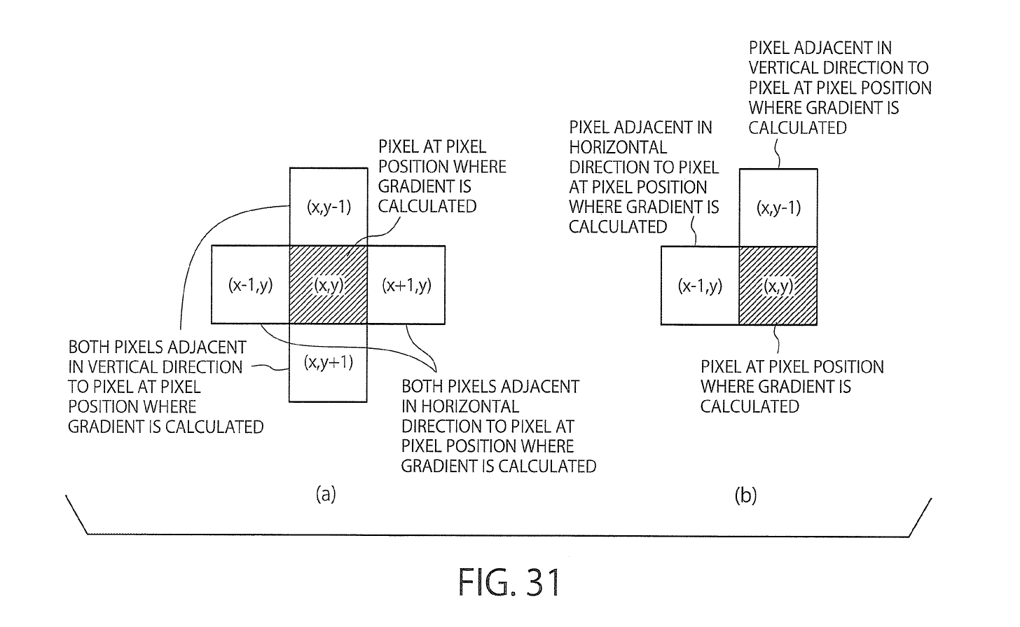

The magnitude of luminance gradient of the input video at each pixel position is calculated by calculating the square-root of sum of squares of the gradient in the horizontal direction and the gradient in the vertical direction at each pixel position of the luminance signal value of the input video signal, for example. The gradient in the horizontal direction and the gradient in the vertical direction at each pixel position are calculated by calculating a difference in the luminance signal value between both pixels adjacent to each pixel in the horizontal direction and between both pixels adjacent to each pixel in the vertical direction. FIG. 31(a) illustrates a positional relationship between these pixels. That is, the magnitude G(x, y) of the gradient of the input video at each pixel position (x, y) can be calculated as follows assuming that the luminance signal value of the input video signal at the pixel position (x, y) is defined as Y(x, y).

ΔₓYᵢₙ(x,y)=Yᵢₙ(x+1,y)−Yᵢₙ(x—1,y)

ΔₓYᵢₙ(x,y)=Yᵢₙ(x,y+1)−Yᵢₙ(x,y—1)

G(x,y)=\sqrt{ΔₓYᵢₙ(x,y)²+Δ_{y}Yᵢₙ(x,y)²} (6)

Formula (6), ΔₓYᵢₙ(x, y) represents the gradient in the horizontal direction of the input video at the pixel position (x, y), and Δ_{y} Yᵢₙ(x, y) represents the gradient in the vertical direction of the input video at the pixel position (x, y).

The magnitude of the gradient of the input video at each pixel position may be calculated by calculating the sum of absolute values of the gradient in the horizontal direction and the gradient in the vertical direction at each pixel position of the luminance signal value of the input video signal. The gradient in the horizontal direction and the gradient in the vertical direction at each pixel position may be calculated by calculating a difference in the luminance signal value between each pixel and a pixel adjacent to the pixel in the horizontal direction, and between each pixel and a pixel adjacent to the pixel in the vertical direction. FIG. 31(b) illustrates a positional relationship between these pixels. That is, the magnitude G(x, y) of the gradient of the input video at each pixel position (x, y) may be calculated as follows assuming that the luminance signal value of the input video signal at the pixel position (x, y) is defined as Y(x, y).

ΔₓYᵢₙ(x,y)=Yᵢₙ(x,y)÷Yᵢₙ(x−1,y)

Δ_{y}Yᵢₙ(x,y)=Yᵢₙ(x,y)—Yᵢₙ(x,y—1)

G(x,y)=|ΔₓYᵢₙ(x,y)|+|Δ_{y}Yᵢₙ(x,y)| (7)

In Formula (7), ΔₓYᵢₙ(x, y) represents the gradient in the horizontal direction of the input video at the pixel position (x, y), and Δ_{y}Yᵢₙ(x, y) represents the gradient in the vertical direction of the input video at the pixel position (x, y).

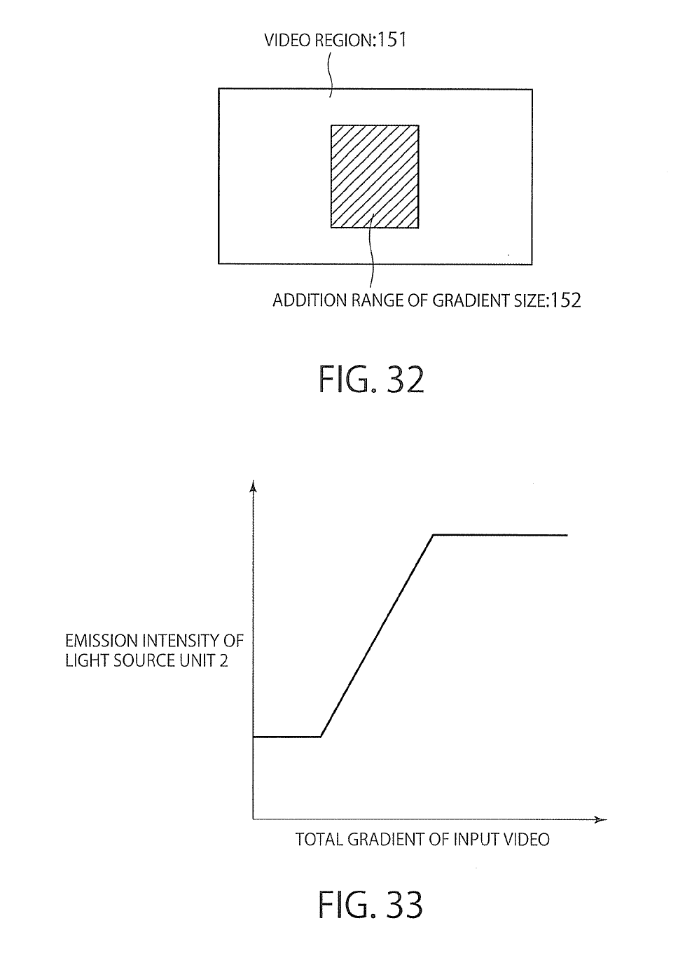

The gradient addition unit 142 calculates the total gradient (that is, the total amount of the gradient) of the input video by sequentially adding the magnitude of the gradient at each pixel position calculated by the gradient calculation unit 141, within an addition range 152 in a video region 151 as illustrated in FIG. 32, for example.

The peak strength determination unit 134 according to this embodiment calculates the emission intensity of the light source unit 2 included in the back light, based on the translation amount calculated by the translation amount calculation unit 131, the brightness of the input video calculated by the brightness calculation unit 132, and the total gradient calculated by the total gradient calculation unit 133.

The peak strength determination unit 134 according to this embodiment calculates the emission intensity of the light source unit 2 such that the emission intensity of the light source unit 2 increases as the total gradient calculated by the total gradient calculation unit 133 increases.

For example, the calculation of the emission intensity of the light source unit 2 in the peak strength determination unit 134 according to this embodiment can be carried out using the LUT (look-up table) in which the total gradient calculated by the total gradient calculation unit 133 is set as the input value and the emission intensity of the light source unit 2 is set as the output value. FIG. 33 illustrates an example of input and output relations in this case.

Alternatively, the peak strength determination unit according to this embodiment may be configured to calculate the input value of the LUT from the translation amount calculated by the translation amount calculation unit 131 and the total gradient calculated by the total gradient calculation unit 133, and calculate the emission intensity of the light source unit 2 by referring to the LUT (look-up table). The input value LUTᵢₙ of the LUT is calculated as follows assuming that the translation amount calculated by the translation amount calculation unit is represented by V; the total gradient calculated by the total gradient calculation unit 133 is presented by Gₜₒₜₐₗ; and the preset constant is represented by V_{MAX}, for example.

LUTᵢₙ=(V−Vₘₐₓ)·Gₜₒₜₐₗ (8)

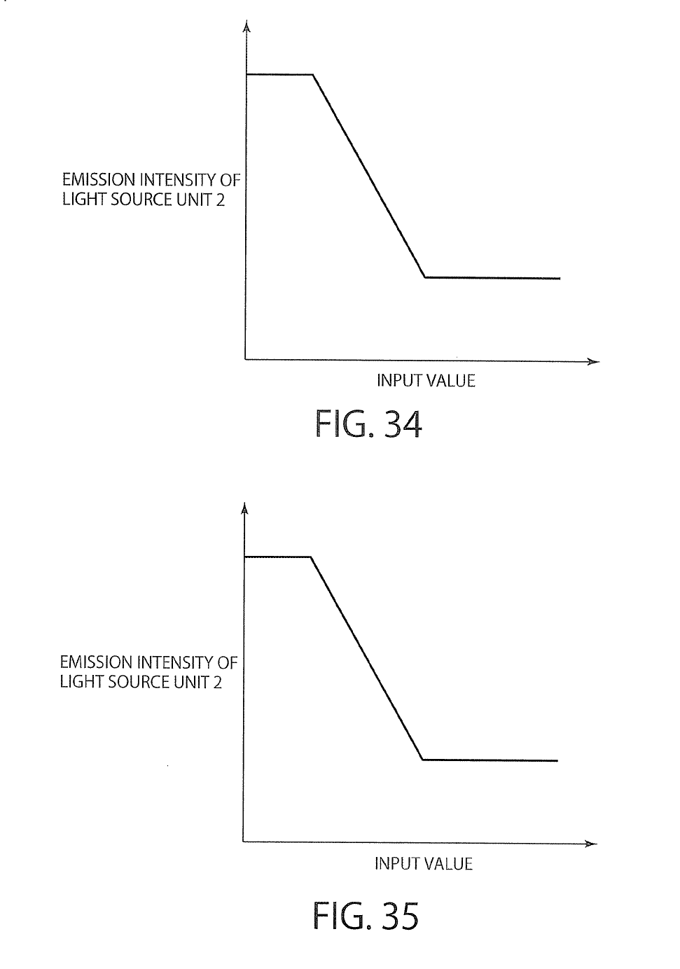

FIG. 34 illustrates an example of input and output relations of the LUT in this case. When V_{MAX} is set to a value sufficiently larger than V, (because the coefficient multiplied by the total gradient calculated by the total gradient calculation unit 133 is negative), the emission intensity of the light source unit 2 is calculated such that the emission intensity of the light source unit 2 decreases as the translation amount (that is, the magnitude of the translational motion included in the input video) calculated by the translation amount calculation unit 131 increase, and the emission intensity of the light source unit 2 increases as the total gradient (that is, the total gradient of the input video) calculated by the total gradient calculation unit 133 increases.

Alternatively, the peak strength determination unit 134 according to this embodiment may be configured to calculate the input value of the LUT from the translation amount calculated by the translation amount calculation unit 131, the brightness of the input video calculated by the brightness calculation unit 132, and the total gradient calculated by the total gradient calculation unit 133, and calculate the emission intensity of the light source unit 2 by referring to the LUT (look-up table). The input value LUTᵢₙ of the LUT is calculated as follows assuming that the translation amount calculated by the translation amount calculation unit 131 is represented by V; the brightness of the input video calculated by the brightness calculation unit 132 is represented by Yₜₒₜₐₗ; the total gradient calculated by the total gradient calculation unit 133 is represented by Gₜₒₜₐₗ; and preset constants are represented by V_{MAX} and k₂, for example.

LUTᵢₙ=(V−Vₘₐₓ)·Gₜₒₜₐₗ+k₂·Yₜₒₜₐₗ (9)

FIG. 35 illustrates an example of input and output relations of the LUT in this case. When V_{MAX} is set to a value sufficiently larger than V, (because the coefficient multiplied by the total gradient calculated by the total gradient calculation unit 133 is negative), the emission intensity of the light source unit 2 is calculated such that the emission intensity of the light source unit 2 decreases as the translation amount (that is, the magnitude of the translational motion included in the input video) calculated by the translation amount calculation unit 131 increases; the emission intensity of the light source unit 2 decreases as the brightness of the input video calculated by the brightness calculation unit 132 increases; and the emission intensity of the light source unit 2 increases as the total gradient (that is, the total gradient of the input video) calculated by the total gradient calculation unit 133 increases.

Alternatively, the gradient calculation unit 141 may calculate the magnitude of the gradient of the input video at each pixel position by calculating the square root of the weighted sum of squares of the gradient in the horizontal direction and the gradient in the vertical direction at each pixel position of the luminance signal value of the input video signal as shown in Formula (6′). Alternatively, as shown in Formula (7′), the magnitude of the gradient of the input video at each pixel position may be calculated by calculating the weighted sum of the absolute values of the gradient in the horizontal direction and the gradient in the vertical direction at each pixel value of the luminance signal value of the input video signal. In Formula (6′) and Formula (7′), w_{Gx} and w_{Gy} represent the weight with respect to the gradient in the horizontal direction and the gradient in the vertical direction, respectively.

G(x,y)=\sqrt{w_{Gx}·ΔₓYᵢₙ(x,y)²+w_{Gy}·Δ_{y}Yᵢₙ(x,y)²} (6′)

G(x,y)=w_{Gx}·|ΔₓYᵢₙ(x,y)|+w_{Gy}·Δ_{y}Yᵢₙ(x,y)| (7′)

For example, in the liquid crystal display device using the backlight as illustrated in FIG. 5(a), the unevenness in the horizontal direction is liable to occur, the visibility of the unevenness is more likely to be affected by the gradient in the horizontal direction of the input video, and is less likely to be affected by the gradient in the vertical direction of the input video. Accordingly, in the liquid crystal display device using the backlight in which the unevenness in the horizontal direction illustrated in FIG. 5(a) is liable to occur, the weight with respect to the gradient in the horizontal direction of the input video which is more likely to be affected by the visibility of the unevenness may be increased, and the weight with respect to the gradient in the vertical direction of the input video which is less likely to be affected by the visibility of the unevenness.

That is, in the gradient calculation unit 141 having the configuration as described above, the weight with respect to the gradient of the input video in the direction parallel to the direction in which the unevenness of the backlight is liable to occur may be preferably increased, and the weight with respect to the gradient of the input video in the direction perpendicular to the direction in which the unevenness of the backlight is liable to occur may be preferably decreased.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image display apparatus comprising:
a backlight including a plurality of light sources, an emission intensity of each light source being controllable;
a modulation unit modulating light emitted from the backlight to display an image on a display region;
a calculation unit configured to calculate an amount of motion of a video between a previous image and a subsequent image based on an input video signal; and
a control unit controlling the light sources such that a non-uniform distribution of brightness is obtained on the display region as the amount of motion decreases.

2. The apparatus according to claim 1, wherein
the backlight includes a first light source unit and a second light source unit,
the first light source unit is configured to radiate light onto an entire surface of the display region, and
the second light source unit is configured to radiate light onto a central region of the display region.

3. The apparatus according to claim 1, wherein
the backlight includes a first light source unit and a second light source unit,
the second light source unit is configured to radiate light onto a central region of the display region,
the first light source unit is configured to radiate light onto an outside of the central region of the display region, and
the second light source unit has a maximum emission luminance higher than a maximum emission luminance of the first light source unit.

4. The apparatus according to claim 2, wherein the control unit is configured to increase an emission luminance of the second light source unit as the amount of motion decreases.

5. The apparatus according to claim 1, wherein the calculation unit determines, as the amount of motion, a value of one having a larger absolute value among a horizontal component and a vertical component of the motion of a video between the previous and subsequent images.

6. The apparatus according to claim 1, wherein the calculation unit determines, as the amount of motion, a square-root of sum of squares of a horizontal component and a vertical component of the motion of a video between the previous and subsequent images.

7. The apparatus according to claim 1, wherein the calculation unit carries out motion estimation on a video of a first region in the previous image, and calculates the amount of motion based on an estimated motion value.

8. The apparatus according to claim 1, wherein
the calculation unit calculates, with respect to a video of a first region in the previous image, a first horizontal one-dimensional projection image by adding signals at each vertical position in a horizontal direction, and calculates a first vertical one-dimensional projection image by adding signals at each horizontal position in a vertical direction,
the calculation unit calculates, with respect to a video of a second region at a same position as that of the first region in the subsequent image, a second horizontal one-dimensional projection image by adding signals at each vertical position in the horizontal direction, and calculates a second vertical one-dimensional projection image by adding signals at each horizontal position in the vertical direction, and
the calculation unit compares the first and second horizontal one-dimensional projection images to detect a motion of a vertical component,
compares the first and second vertical one-dimensional projection images to detect a motion of a horizontal component, and
calculates the amount of motion based on the motion of the vertical component and the motion of the horizontal component.

9. The apparatus according to claim 1, wherein the control unit control the light sources such that brightness at the center in the display region becomes relatively higher as the amount of motion decreases.

10. The apparatus according to claim 3, wherein the control unit makes the emission intensity of the second light source higher than that of the first light source as the amount of motion decreases.

11. The apparatus according to claim 4, wherein the control unit sets the emission intensity of the first light source to a reference emission intensity regardless of the amount of motion.

12. The apparatus according to claim 4, further comprising a look-up table including an amount of motion and emission intensity of the second light source unit, and
the control unit determines the emission intensity of the second light source unit by using the look-up tables based on the amount of motion calculated by the calculation unit.

13. The apparatus according to claim 1,
the calculation unit calculates, with respect to a video of a given region in the input image, a total of luminance at each pixel and
the control unit controls the light sources such that a non-uniform distribution of brightness is obtained on the display region as the total of luminance decreases.

14. The apparatus according to claim 1,
the calculation unit calculates, with respect to a video of a given region in the input image, calculates luminance gradient at each pixel based on difference of luminance from an adjacent pixel in a horizontal direction and difference of luminance from an adjacent pixel in a vertical direction at each pixel and
the control unit controls the light sources such that a non-uniform distribution of brightness is obtained on the display region as a total of each calculated luminance gradient increases.

15. An image display method comprising:
displaying an image in a display region by modulating light emitted from a backlight, the backlight including a plurality of light sources, an emission intensity of each light source being controllable;
calculating an amount of motion of a video between a previous image and a subsequent image based on an input video signal; and
controlling the light sources such that a non-uniform distribution of brightness in the display region is obtained as the amount of motion decreases.
